(19) United States
(12) Patent Application Publication
(10) Pub. No.: US 2024/0419950 A1
(43) Pub. Date: Dec. 19, 2024

(54) SYSTEMS, DEVICES, AND METHODS FOR ENTERPRISE SYSTEM INTEGRATION USING MACHINE LEARNING

(71) Applicant: Neural Enterprises Inc., Kirkland, WA (US)

(72) Inventors: Richard Chia Tsing TONG, Seattle, WA (US); Satoshi NAKAJIMA, Medina, WA (US); Paul DAVIS, Kirkland, WA (US); Deon BLAAUW, Lisse (NL)

(21) Appl. No.: 18/744,018

(22) Filed: Jun. 14, 2024

Related U.S. Application Data
(60) Provisional application No. 63/508,857, filed on Jun. 16, 2023.

(51) Int. Cl. G06N 3/0475; G06F 9/54; G06N 3/045

(52) U.S. Cl. CPC G06N 3/0475; G06F 9/541; G06N 3/045

(57) ABSTRACT

A method for directing a domain-specific request to a machine learning (ML) agent of a plurality of ML agents configured to generate domain specific language (DSL) scripts includes, at a computing system: processing a request received from a user to determine a particular domain associated with the request; identifying an ML agent of the plurality of ML agents that is associated with the particular domain; generating, using the ML agent, a DSL script for the particular domain based on the request; executing, using the ML agent, at least one of an API call and a database query based on the DSL script; processing, using the ML agent, a response to the at least one of the API call and the database query; generating, using the ML agent, an output based on the response; and processing the output using at least one other ML agent of the plurality of ML agents.

### CROSS REFERENCE SECTION

This application claims priority to U.S. Provisional Patent Application No. 63/508,857 filed on Jun. 16, 2023, the entirety of which is incorporated herein by reference.

### FIELD

This disclosure relates generally to enterprise systems integration, and more specifically to enterprise systems integration using machine learning.

### BACKGROUND

The technological landscape of enterprise environments is complex and multifaceted, including a multitude of systems such as customer relationship management (CRM), enterprise resource planning (ERP), database management, and even legacy systems that may not be compliant with modern integration standards. Traditional methods of system integration often utilize the Enterprise Service Bus (ESBs) architecture, which necessitates extensive manual integration work. This process is labor-intensive, time-consuming, and does not scale effectively with the increase in the number of systems or the diversity in their compliance levels. Moreover, the traditional methods for systems integration lack the flexibility required to adapt to rapidly changing business requirements and technological advancements.

Another significant challenge with enterprise systems is the difficulty in properly ingesting and processing unstructured data from sources (such as PDFs for example), which often contain important information like standard operating procedures, manuals, and other critical documents. Legacy systems may not comply with more modern architectures, such as ESB. Thus, a significant amount of information, while vital to business operations, is often locked away in formats that are hard to query and integrate into the broader information ecosystem. The inability to easily incorporate this data into enterprise systems can lead to information silos and missed opportunities for data-driven insights and decisions. Further, information retrieved from any of these enterprise systems according to traditional integration methods is often displayed to users via statically coded user interfaces. Development of these interfaces is often costly and time-consuming, with significant resources needed to code, test, and maintain these interfaces. Furthermore, statically coded user interfaces lack the dynamic adaptability needed to cope with evolving business needs and data structures.

### SUMMARY

Disclosed herein are systems and methods for enterprise systems integration that leverage specialized machine learning (ML) models, such as specialized Large Language Models (LLMs), to dynamically generate scripts for retrieving information from respective enterprise systems, such as CRM systems, ERP systems, database management systems, etc. These methods also make these ML models enterprise ready as LLMs are subject to hallucinations and are generally not designed with enterprise reliability and scalability in mind. This capability can be harnessed using ML agents, each of which may include a specialized ML model such as an LLM, to generate Domain-Specific Language (DSL) instructions for communicating with different enterprise systems, enabling a more flexible, reliable, scalable, adaptive, and automated integration process, significantly minimizing the need for manual coding. LLMs can also be used to dynamically reconfigure user interfaces based on data context and user instruction, thereby addressing the inherent inflexibility of statically coded user interfaces and reducing the resources needed for their development and maintenance.

LLMs may interface with legacy systems, including those that are not ESB compliant, thereby enhancing the scope of the integration process. Unlike traditional integration methods that often encounter difficulties incorporating legacy systems not compliant with modern protocols, such as the Enterprise Service Bus (ESB), systems and methods described herein may integrate a wider range of systems, including legacy ones, by translating their functionalities into one or more DSLs that an LLM can understand and interact with. These capabilities may allow users to launch advanced queries across the entire enterprise, breaking down information silos and enhancing decision-making processes and at the same time delivering the speed and accuracy that are a must for enterprise applications.

According to some examples, requests from users and/or ML agents may be dynamically routed to appropriate ML agents based on a particular domain associated with the request. The requests may be processed using the ML agents to generate DSL scripts that can be used to call APIs and/or query databases to retrieve data associated with the particular domain. An ML agent may process the received data to generate outputs that can be used to dynamically update user interfaces, generate multimedia, and/or execute system control actions (e.g., for robotics systems). The systems (e.g., using one or more ML agents) may ensure that the ML agent returns requests which are accurate and fast.

According to an aspect, an exemplary method for directing a domain-specific request to a machine learning (ML) agent of a plurality of ML agents configured to generate domain specific language (DSL) scripts comprises, at a computing system: processing a request received from a user to determine a particular domain associated with the request; identifying an ML agent of the plurality of ML agents that is associated with the particular domain; generating, using the ML agent, a DSL script for the particular domain based on the request; executing, using the ML agent, at least one of an API call and a database query based on the DSL script; processing, using the ML agent, a response to the at least one of the API call and the database query; generating, using the ML agent, an output based on the response; and processing the output using at least one other ML agent of the plurality of ML agents.

Optionally, the request is processed by another ML agent to determine the particular domain associated with the request before transmitting the request to the orchestrator.

Optionally, the request is based on a natural language prompt received via a user interface.

Optionally, the request comprises a natural language prompt generated by another ML agent of the plurality of ML agents.

Optionally, the request comprises at least one of text data, image data, and audio data.

Optionally, the orchestrator is configured to determine the appropriate ML agent by comparing the particular domain associated with the request to a DSL definition of the ML agent.

Optionally, the DSL definition of the ML agent comprises an indication of an ability to generate a DSL script for the particular domain associated with the request.

Optionally, the DSL definition of the ML agent is specified via a manifest file definition of the ML agent.

Optionally, the orchestrator is configured to dynamically utilize server-side computing resources, client-side computing resources, or a combination thereof based on an availability of computing resources.

Optionally, any one or more of the plurality of ML agents is configured to dynamically utilize server-side computing resources, client-side computing resources, or a combination thereof based on an availability of computing resources.

Optionally, the output is transmitted to a user interface ML agent trained to reconfigure a user interface based on the output.

Optionally, the method comprises: receiving, by the user interface ML agent, a user input via the user interface; and reconfiguring the user interface based on the user input.

Optionally, reconfiguring the user interface comprises: selecting one or more widgets based on the user input and data included in the response from at least one of the API and the database.

Optionally, a DSL interpreter interprets the DSL script during runtime to execute at least one of an API call and a database query based on the DSL script.

Optionally, the DSL interpreter is included in the ML agent.

Optionally, the output is transmitted to each of the plurality of ML agents for validating the output.

Optionally, validating the output comprises performing a consensus protocol by the plurality of ML agents based on pretrained knowledge of the subset of the plurality of ML agents and external data sources.

Optionally, each ML agent of the plurality of ML agents comprises an LLM trained for a different task than an LLM of each of the other ML agents of the plurality of ML agents.

According to an aspect, an exemplary non-transitory computer readable storage medium stores instructions for directing a domain-specific request to a machine learning (ML) agent of a plurality of ML agents configured to generate domain specific language (DSL) scripts, the instructions configured to be executed by one or more processors of a computing system to cause the system to: process a request received from a user to determine a particular domain associated with the request; identify an ML agent of the plurality of ML agents that is associated with the particular domain; generate, using the ML agent, a DSL script for the particular domain based on the request; execute, using the ML agent, at least one of an API call and a database query based on the DSL script; process, using the ML agent, a response to the at least one of the API call and the database query; generate, using the ML agent, an output based on the response; and process the output using at least one other ML agent of the plurality of ML agents.

Optionally, the request is processed by another ML agent to determine the particular domain associated with the request before transmitting the request to the orchestrator. Optionally, the request is based on a natural language prompt received via a user interface. Optionally, the request comprises a natural language prompt generated by another ML agent of the plurality of ML agents. Optionally, the request comprises at least one of text data, image data, and audio data. Optionally, the orchestrator is configured to determine the appropriate ML agent by comparing the particular domain associated with the request to a DSL definition of the ML agent. Optionally, the DSL definition of the ML agent comprises an indication of an ability to generate a DSL script for the particular domain associated with the request. Optionally, the DSL definition of the ML agent is specified via a manifest file definition of the ML agent.

Optionally, the orchestrator is configured to dynamically utilize server-side computing resources, client-side computing resources, or a combination thereof based on an availability of computing resources. Optionally, any one or more of the plurality of ML agents is configured to dynamically utilize server-side computing resources, client-side computing resources, or a combination thereof based on an availability of computing resources. Optionally, the output is transmitted to a user interface ML agent trained to reconfigure a user interface based on the output.

Optionally, the instructions configured to be executed by one or more processors of the computing system are configured to cause the system to: receive, by the user interface ML agent, a user input via the user interface; and reconfigure the user interface based on the user input. Optionally, reconfiguring the user interface comprises: selecting one or more widgets based on the user input and data included in the response from at least one of the API and the database. Optionally, a DSL interpreter interprets the DSL script during runtime to execute at least one of an API call and a database query based on the DSL script. Optionally, the DSL interpreter is included in the ML agent.

Optionally, the output is transmitted to each of the plurality of ML agents for validating the output. Optionally, validating the output comprises performing a consensus protocol by the plurality of ML agents based on pretrained knowledge of the subset of the plurality of ML agents and external data sources. Optionally, each ML agent of the plurality of ML agents comprises an LLM trained for a different task than an LLM of each of the other ML agents of the plurality of ML agents.

According to an aspect, an exemplary system for directing a domain-specific request to a machine learning (ML) agent of a plurality of ML agents configured to generate domain specific language (DSL) scripts comprises one or more processors and memory storing one or more computer programs that include computer instructions, which when executed by the one or more processors, cause the system to: process a request received from a user to determine a particular domain associated with the request; identify an ML agent of the plurality of ML agents that is associated with the particular domain; generate, using the ML agent, a DSL script for the particular domain based on the request; execute, using the ML agent, at least one of an API call and a database query based on the DSL script; process, using the ML agent, a response to the at least one of the API call and the database query; generate, using the ML agent, an output based on the response; and process the output using at least one other ML agent of the plurality of ML agents.

Optionally, the request is processed by another ML agent to determine the particular domain associated with the request before transmitting the request to the orchestrator. Optionally, the request is based on a natural language prompt received via a user interface. Optionally, the request comprises a natural language prompt generated by another ML agent of the plurality of ML agents. Optionally, the request comprises at least one of text data, image data, and audio data. Optionally, the orchestrator is configured to determine the appropriate ML agent by comparing the particular domain associated with the request to a DSL definition of the ML agent. Optionally, the DSL definition of the ML agent comprises an indication of an ability to generate a DSL script for the particular domain associated with the request. Optionally, the DSL definition of the ML agent is specified via a manifest file definition of the ML agent.

Optionally, the orchestrator is configured to dynamically utilize server-side computing resources, client-side computing resources, or a combination thereof based on an availability of computing resources. Optionally, any one or more of the plurality of ML agents is configured to dynamically utilize server-side computing resources, client-side computing resources, or a combination thereof based on an availability of computing resources. Optionally, the output is transmitted to a user interface ML agent trained to reconfigure a user interface based on the output.

Optionally, the one or more computer programs that include computer instructions, when executed by the one or more processors, cause the system to: receive, by the user interface ML agent, a user input via the user interface; and reconfigure the user interface based on the user input. Optionally, reconfiguring the user interface comprises: selecting one or more widgets based on the user input and data included in the response from at least one of the API and the database. Optionally, a DSL interpreter interprets the DSL script during runtime to execute at least one of an API call and a database query based on the DSL script. Optionally, the DSL interpreter is included in the ML agent.

Optionally, the output is transmitted to each of the plurality of ML agents for validating the output. Optionally, validating the output comprises performing a consensus protocol by the plurality of ML agents based on pretrained knowledge of the subset of the plurality of ML agents and external data sources. Optionally, each ML agent of the plurality of ML agents comprises an LLM trained for a different task than an LLM of each of the other ML agents of the plurality of ML agents.

In some embodiments, any one or more of the characteristics of any one or more of the systems, methods, and/or computer-readable storage mediums recited above may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1A illustrates an exemplary system for enterprise systems integration using specialized machine learning models according to some examples.

FIG. 1B illustrates a more detailed depiction of a plurality of ML agents that may be utilized in the system of FIG. 1A for enterprise systems integration according to some examples.

FIG. 2 illustrates an exemplary method for enterprise systems integration that utilizes a decentralized orchestrator according to some examples.

FIG. 3 illustrates an exemplary domain specific language (DSL) definition according to some examples.

FIG. 4 illustrates another exemplary method for enterprise systems integration that may not utilize an orchestrator according to some examples.

FIG. 5 illustrates a representation of data flow through a system that either does not utilize an orchestrator and/or in which the orchestrator is bypassed according to some examples.

FIG. 6 illustrates an exemplary swim lane diagram of information flowing through a network of ML agents and resources called by the ML agents (e.g., APIs and databases of CRM systems, inventory systems, etc.) according to some examples.

FIG. 7 illustrates an exemplary system architecture of a system for enterprise systems integration according to some examples.

FIG. 8 illustrates an exemplary ML agent according to some examples.

FIG. 9 illustrates an exemplary user interface for configuring an ML agent according to some examples.

FIG. 10 illustrates the exemplary user interface of FIG. 9 for configuring an ML agent that has been used to configure a different ML agent according to some examples.

FIG. 11 illustrates an exemplary expert that includes a plurality of ML agents according to some examples.

FIG. 12 illustrates an exemplary user interface for constructing an expert according to some examples.

FIG. 13 illustrates the exemplary user interface of FIG. 12, which has been used to construct an expert for processing a call transcript according to some examples.

FIG. 14 illustrates the exemplary user interface of FIG. 12 and FIG. 13, which has been used to construct an expert for fashion data analysis according to some examples.

FIG. 15 illustrates an exemplary computing device according to some examples.

### DETAILED DESCRIPTION

Disclosed herein are systems, devices, and methods that leverage specialized machine learning (ML) models, such as specialized large language models (LLMs) that can be trained, retrained, and finetuned to generate domain specific language (DSL) scripts for enterprise systems integration. The systems, devices, and methods disclosed herein may enable enterprise systems, including legacy systems, to communicate and interact with each other with significantly less manual coding required compared to traditional integration methods, providing a more dynamic, adaptable, and scalable solution. The systems and methods described herein may allow for ingesting and on demand querying of vast amount of proprietary company information including, but not limited to pdfs, images, videos, text, email, chat messages, and much more.

According to some examples, the systems, devices, and methods disclosed herein employ a plurality of ML agents, each including a machine learning model, such as a transformer model, deep neural network (DNN), and/or convolutional neural network (CNN). In some examples, one or more ML agents include a specialized deep learning model, such as a transformer model, trained to receive input data, encode the input data by transforming the input data into lower dimensional embedding vectors representative of the input data, and decode the encoded data to generate a predicted output. In some examples, one or more ML agents include a specialized language model (e.g., a relatively small language model trained using fewer parameters than a relatively larger language model and/or a language model trained/finetuned for a particular specialized task). In some examples, one or more ML agents include a large language model (e.g., a language model such as GPT4 trained using additional parameters relative to the smaller models). In some examples, one or more of the LLM agents may utilize a machine learning model, such as model that implements a transformer architecture, to generate DSL scripts that enable the respective ML agent to communicate with an enterprise system associated with a particular domain. The language models included in respective ML agents may be referred to herein as “LLMs” regardless of the relative size and/or specialization of the respective models. Users may interact with an exemplary system to request information associated with different enterprise systems, and thus the respective domains associated with those enterprise systems, and one or more ML agents may process the request to generate outputs responsive to those requests. Data may be retrieved from a respective system using specialized DSL scripts executed by software included in a respective ML agents to call APIs and/or query databases and ML agents may dynamically configure user interfaces based on the retrieved data to display relevant information to the user.

As an example, a user may input a request (e.g., a natural language prompt) via a user interface. The request may be processed using an ML agent to determine a context of the request, which may include a particular domain associated with the request. The request and particular domain may then be sent by the ML agent to an “orchestrator” that identifies an appropriate ML agent for communicating with the particular domain. As used herein, the orchestrator may refer to decentralized software configured to run either locally (e.g., on a client device), remotely (e.g., on a server), or a combination thereof, and configured to dynamically distribute workload (e.g., requests, prompts, etc.) between a plurality of ML agents. The orchestrator may compare the request and the indication of the domain to contexts of a plurality of ML agents to determine which ML agent is best suited to retrieve the requested information from a given domain. As used herein, the “context” of an ML agent may refer to a semantic description of the respective ML agent's capabilities and/or a DSL definition of the ML agents, which may define the particular DSL in which the ML agent is configured to communicate. In some examples, the ML agent may instead publish the request and its context to all other ML agents, and the respective ML agents may compare the context of the request (e.g., the particular domain) to their own context to determine if it is relevant to their context. If it is, the respective ML agent may process the request.

The orchestrator may run multiple ML agents simultaneously or in sequence. The orchestrator may determine that one or more ML agents are slower for some tasks but more reliable than one or more other ML agents for other tasks and may thus utilize ML agents according to their relative strengths. The orchestrator may select an ML relatively smaller ML agent for certain tasks and relatively larger ML agents for other tasks. The orchestrator may utilize various hardware for running one or more ML agents, for example the end-user's computer, a small local server providing lower cost and/or faster response but which potentially may produce less high fidelity answers, and/or a more powerful remote server, depending on requirements for a given prompt and/or based on available compute across various systems. The orchestrator may also predict what user requests are likely to be made and initiate ML agents speculatively because the orchestrator may determine that faster response time is desirable and the additional cost to run and sometimes “throw away” or otherwise discard a response is a proper tradeoff for relatively faster response time.

Upon receipt of the request by the appropriate ML agent, the ML agent may broadcast a message to other agents in the network (e.g., to indicate it is processing the request) and may process the request to generate a DSL script. The DSL script may be utilized to retrieve information based on the request from a particular domain (e.g., a CRM system, database, ERP system, etc.), for instance, by executing one or more API calls and/or database queries. The DSL script may be executed by software such as a DSL interpreter included in the respective ML agent. The ML agent may generate an output based on data retrieved from the particular domain via the API calls and/or database queries, which may be provided to another ML agent along with the data context (e.g., metadata that describes the data). The ML agent receiving the retrieved data may dynamically reconfigure a user interface based on the received data and its context, to display information responsive to the user's request. The ML agent may also send multiple requests to different agents in a “scatter-gather” configuration for performance reasons, so it may send a request to some agents to access small and fast local databases and also send a request to more computationally intensive ML agents in remote cloud databases. The ML agent may use response time or cost constraints to decide in some instances to take the small and fast data gathered to server the request and then update the system when the longer running ML agents return their results providing both fast response and high accuracy.

ML agents may include an LLM or other machine learning model that has been configured and trained to communicate with a specific enterprise system in a particular DSL and/or perform other specific tasks, such as user-interface configuration. Furthermore, any of the ML agents may be periodically and/or continuously retrained and/or fine tuned for its respective task based on new data ingested into the system, interactions with users, and/or interactions with other ML agents. Accordingly, the system may improve as additional interactions are recorded and additional data is ingested as each of the ML agents may be iteratively and/or continuously updated to adapt to changes in user preferences and more up-to-date information. These ML agents as they are retrained and returned may run multiple version of ML agents in parallel. In some embodiments, a slower but highly accurate ML agent may serve as “reference standard” for the system. As fine tuned agents are brought on line, the orchestrator may be instructed to run the highly accurate but slower model on a percentage of the queries and run different versions of the fine tuned models in parallel. This allows the system to provide high accuracy and also dynamically check the result of fine tuned models. The system may, in one example, run the slower but accurate model in batch to check the results of the fine tuned model so response time is fast, but checking is done after the queries to ensure quality. The system in another example may run the slow and accurate model on a percentage of the queries. If the ML agent detect that the fine tuned model is not accurate enough, it may notify the orchestrator to suspend or limit the use of any of the collection of fine tuned models and use the slow but more accurate models until the smaller models are retrained appropriately and can be brought back on line.

The present disclosure provides numerous technical advantages over existing enterprise systems integration methods. The systems, devices, and methods described herein leverage the capabilities of large language models to automate the generation of scripts for system integration. This reduces the need for manual coding, which is time-consuming, error-prone, and requires specialized expertise. Consequently, the speed and efficiency of the integration process is significantly improved. The LLMs, in the approach described herein, are capable of creating dynamically reconfigurable user interfaces. These interfaces adapt based on what information a user wishes to view and how they want this data displayed, offering a highly personalized and intuitive user experience. This stands in stark contrast to traditional, statically-coded interfaces, which lack such responsive capabilities.

The systems described herein can interface with a broad array of enterprise systems, including legacy systems that may not comply with modern integration protocols like the Enterprise Service Bus (ESB). The functionalities of these diverse systems are translated into a Domain-Specific Language (DSL) that an LLM of a respective ML agent can interact with, providing a versatile solution for integrating disparate systems. The decentralized network of ML agents enables scalability. New agents can be incorporated into the network without disrupting or requiring modifications to existing ones. This capacity for seamless expansion allows the integration of more systems as an enterprise grows, making the solution particularly scalable for growing businesses. While LLMs can potentially generate data hallucinations, the application of hallucination detection techniques, such as the consensus protocol described herein, mitigates this risk, thereby ensuring the integrity of the data generated by the LLMs and the overall reliability of the integration process.

The inclusion of a decentralized orchestrator/dispatcher may provide an additional layer of control over the flow of communication between different agents. This flexible design accommodates both a decentralized and a controlled flow of communication, depending on an enterprise's specific needs. Thus, the systems, devices and methods described herein present a solution to business challenges associated with system integration, including efficiency, scalability, and versatility, by leveraging a distinctly technological approach. It harnesses and extends the capabilities of LLMs, integrates them with other systems using a unique DSL-based method, and maintains data integrity through the use of hallucination detection techniques. These are fundamentally technical solutions that provide substantial advancements over the existing state of the art in system integration.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMS, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

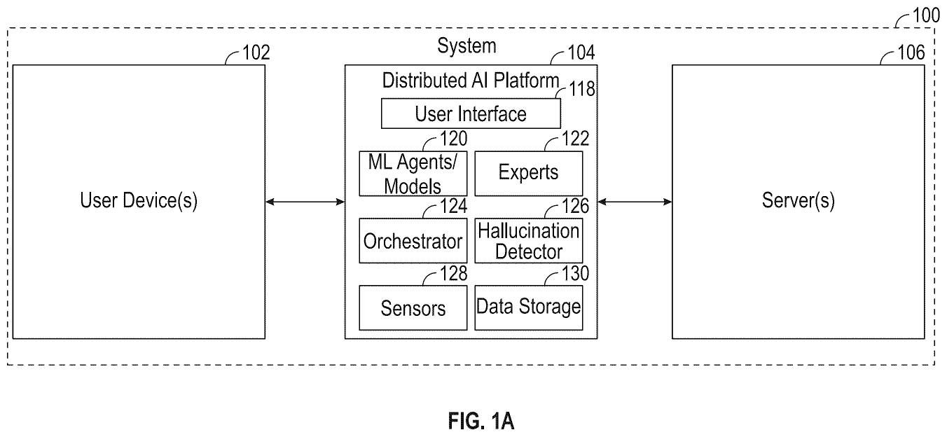

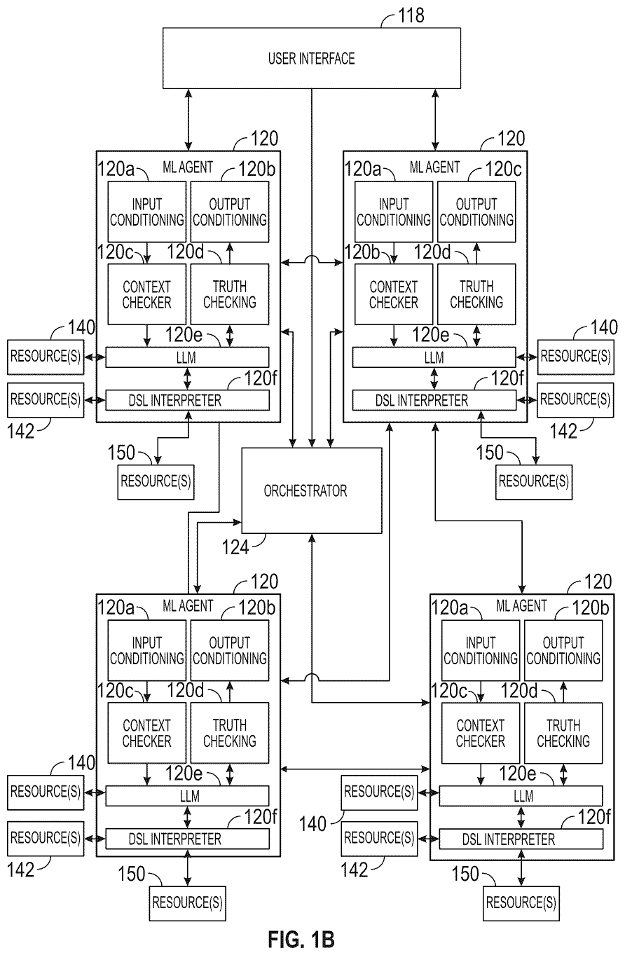

FIG. 1A illustrates an exemplary system 100 that utilizes ML agents for enterprise systems integration. The system 100 may include a distributed AI platform 104 connected to one or more user devices 102 and one or more servers 106. The distributed AI platform 104 may be configured to operate locally at one or more user devices 102 and or at one or more servers 106. Any one or more of the components of the AI platform 104 may run at the user devices 102, at one or more server 106, or may utilize a combination of compute resources of the user devices 102 and/or the server(s) 104, for instance, to process requests from users received via a graphical user interface displayed at one or more user devices 102, as described in additional detail below. The distributed AI platform 104 may utilize a plurality of ML agents 120 and/or a plurality of experts 122, which as described below, may include multiple ML agents 120 and/or nested experts 122 each including multiple ML agents 120, for integrating enterprise systems. To do so, the ML agents 120 and/or a plurality of experts 122 may be configured to communicate with different enterprise systems in domain specific languages (DSLs) using specialized machine learning models that generate DSL scripts, as described in further detail below.

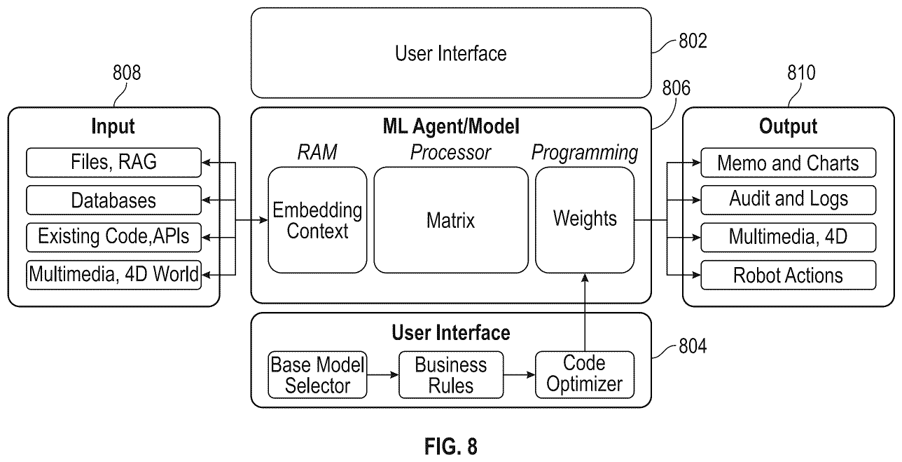

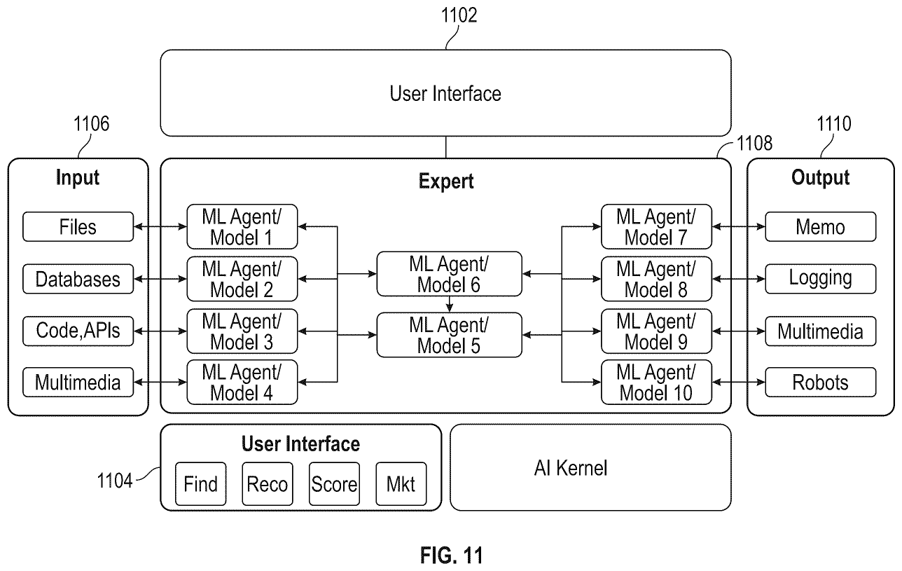

The ML agents 120 and/or a experts 122 may be configured to process inputs received (e.g., from users, data sources, and/or other ML agents and experts) to generate outputs utilizing specialized machine learning models for particular tasks (e.g., LLMs trained, finetuned, and continuously retrained, reconfigured, or otherwise updated to enhance their ability to perform the particular task). As used herein, an ML agent 120 may include a machine learning model such as an LLM (e.g., a transformer model) and computer executable code for carrying out one or more particular tasks. In some instances, ML agents 120 may also be referred to herein as a “model,” for instance, in the exemplary model depicted in FIG. 8 and the exemplary expert depicted in FIG. 11. ML agents 120 may include, be connected, and/or be configured to connect to particular data sources with which they are configured to interact (e.g., ingest and process data from). In some examples, ML agents may be configured to generate computer executable scripts for particular domains, e.g., in a domain specific language DSL. The ML agents may include DSL interpreters that execute API calls and/or database queries to retrieve data and/or perform actions associated with inputs received from users and/or other ML agents.

The ML agents 120 may be configured to condition inputs received from users and/or other ML agents 120, for instance, by removing extraneous text. The ML agents 120 may be configured to compare context (e.g., semantic descriptions, such as an indication of a particular domain associated with an input) of inputs and/or data they receive to determine whether the inputs are relevant to their particular capabilities. For instance, if an input requests data from a particular database with which the ML agent 120 is not configured to query (because it is not configured to generate DSL scripts for that particular database), the ML agent 120 may ignore the input. Additional detail on how a user can utilize the AI platform 104 to construct a custom ML agent is provided below.

The experts 122 may include multiple ML agents and/or multiple specialized machine learning models (e.g., LLMs). Experts 122 may additionally include and/or be connected to particular data sources with which they are configured to interact (e.g., ingest and process data from) and/or may include instructions for writing outputs generated by the expert 122 to any of a plurality of memory storage components of system 100. For example, an expert 122 may include a plurality of ML agents 120, each ML agent 120 configured to perform a specific task within a processing pipeline. One or more ML agents 120 forming an expert 122 may be configured to generate DSL scripts and execute API calls/database queries based on those DSL scripts, for instance, to retrieve data or dynamically configure a user interface. One or more ML agents 120 forming an expert 122 may be configured to process retrieved data. In some examples, a single agent may be configured to perform multiple tasks (e.g., data retrieval and data processing). In some examples, multiple agents may be configured to perform the same task but run on different hardware embodiments that may provide better response time or more processing power for higher accuracy. One or more of the machine learning models included in the ML agents 120 forming a given expert 122 may be relatively small, specialized machine learning models (e.g., a small language model trained using fewer parameters, higher level of quantization than a relatively larger language model, such as an LLM like GPT4). In some examples, the experts 120 may include a relatively larger machine learning model and lower quantization (e.g., an LLM trained using relatively more parameters such as GPT4).

In some examples, the ML agents 120 and/or experts 122 are managed by an orchestrator 124 included in AI platform 104. The orchestrator 124 may be a software module that includes a dispatcher that routes traffic between components of the system. For instance, orchestrator 124 may dynamically route inputs received from a user to one or more experts 122 and/or to one or more ML agents 120. The orchestrator 124 can run server-side (e.g., on the cloud), client-side (e.g., in a web browser) or a combination thereof. The orchestrator 124 may run as many resources (e.g., ML agents 120, experts 122, etc.) as it can client-side (e.g., on one or more user devices 104, for instance, on a web browser), and it may progressively back off into a cloud environment (e.g., server 106) if it determines there are insufficient client-side resources (e.g., compute) while maintaining a thin layer on a web browser of the user device. On edge devices, smaller LLMs can run (e.g., 7-10 billion parameters). Accordingly, if a user is utilizing a relatively smaller LLM of an ML agent 120 and/or expert 122, the orchestrator may run the LLM on a web browser of the user device to save cloud compute costs and to take advantage of low latency at the edge device. More compute intensive resources such as larger LLMs may be run on the server 106. The orchestrator 124 may also dynamically select from available upstream LLM providers (OPENAI, ANTHROPIC), e.g., if an API endpoint is down or too much latency. Thus, the orchestrator 124 provides an additional layer of control and flexibility in managing the network of ML agents 120 and/or experts 122 (e.g., as opposed to relying solely on direct communications between ML agents 120 and/or experts 122.

The orchestrator 124 may examine the entire network of ML agents 120 and experts 122 that need to be run and may determine the optimal order of execution. In some examples, the orchestrator 124 may analyze all the ML agents 120 and experts 122 that need to run, calculate the projected run time and availability of data as one ML agent 120 may provide output to another ML agent 120. The orchestrator 124 may construct a list of ML agents 120 available to run across all user requests and operations in the system 100. The orchestrator 120 may schedule them to minimize the response time or minimize cost or maximize hardware utilization of servers 106 and devices 102 or any other parameters set by the system. In one embodiment, the orchestrator may have several different ML agents 120 or ML Experts 122 ready to run but only one available hardware embodiment, it may then choose to run the ML Agent 120 which is blocking the execution on other servers that are idle. In this way, the orchestrator 124 can maximize hardware servers 106 or user devices 102 being used at one time. In some examples, the orchestrator 124 may choose to minimize the response time to the user, and so may choose to prioritize the ML Agents 120 which will deliver the fastest response time and block execution from other ML Agents 120 which may in some examples use all the available hardware in devices 102 or servers 106, thereby blocking ML Agents 120 or Experts 124 which have real-time needs.

In some examples, AI platform 102 includes a hallucination detector 126 configured to check the outputs generated by the one or more machine learning models (e.g., included in ML agents 120 and/or experts 122) for consistency (e.g., with an input) and truth to mitigate hallucination issues sometimes associated with LLMs. Hallucination detection (e.g., truth checking) may be done by means of dynamic collaborative consensus, in which a group of LLMs (for instance, a group of ML agents 120 using their respective LLMs) deliberate on a given question and answer set (e.g., an input received by a user and/or ML agent or expert and an output generated by an LLM of an ML agent or expert), using a combination of inherent pretrained knowledge and external data sources to determine the consistency and accuracy of the output. An output may be determined to be consistent and/or accurate if consensus is reached. In some examples, consensus may be reached when a sufficient number of LLMs of the hallucination detector 126 agree that the response is consistent and accurate. In some examples, all LLMs of the hallucination detector 126 must agree to reach consensus. External data sources used during the collaborative consensus protocol may include, but are not limited to, digital systems as well as human induced feedback.

The hallucination detector 126 may in some examples, use the orchestrator 124 to use different ML agents 120 or experts 122 with different computation cost and response times. The hallucination detector 126 may in some examples have some ML agents 120 which are large and slow (such as GPT4) and some ML agents 120 or experts 122 which are fast or which may run on different hardware such as a dedicated server or the end-user client computer. The hallucination detector 126 may run multiple ML agents to deliberate and take into account in some examples the response time needed and the likelihood of a hallucination. The hallucination detector 126 may run multiple ML agents and when the response cut off is reached in servers 106 or user devices 102, it may dis-guard the slow running agents and just some of the ML agents 120 or ML experts 122 results and make a decision to meet response time needs. The hallucination detector 126 may also be configured to statistically run different ML agents so that in some examples if the ML expert 122 is highly reliable, it may only run fast checks, but if an ML expert is new to the system then it may run the complete range of ML agents to check the result at the cost of slower response time but better accuracy. The hallucination detector 126 may also be configured to learn dynamically what user inputs are likely to generate hallucinations by keeping a list of inputs to ML agents 120 and/or expert 122. The hallucination detector 126 may compare the inputs to these experts and use an ML agent 120 to determine if the input is different enough from previous inputs and is therefore more likely to cause a hallucination. The hallucination detector 126 may in some examples, change the mix of ML agents 120 or expert 122 based on the difficulty of the input to the ML agent under test and based on the system cost criteria for response time and process utilization.

In some examples, ML agents 120 and/or experts 122 utilize gRPC (Google Remote Procedure Call), a high-performance, open-source framework that allows for the efficient intercommunication between agents. The gRPC communication protocol provides several key advantages, such as low latency and efficient binary data serialization, making it a robust choice for agent communication. However, the design of system 100 is not tied to gRPC. It maintains the flexibility to incorporate other communication protocols that offer similar benefits. Accordingly, if the landscape of communication protocols evolves, or if a particular deployment scenario calls for a different approach, system 100 can adapt. This ensures that the inter-agent communication in system 100 remains efficient, robust, and in line with the most effective technological practices. Furthermore, where gRPC is not practical, REST API calls over HTTP may be used, or other approaches for process communication.

AI platform 104 may be connected to and/or include a plurality of sensors 128 for ingesting data that can be used to train one or more machine learning models (e.g., LLMs) of ML agents 120 and/or experts 122. Data ingested from sensors 128 may additionally or alternatively be processed and stored in a memory such as data storage 130 such that the ML agents 120 and/or experts 122 can later call data ingested from the sensors 128 to respond to inputs received from users of AI platform 104 and/or other ML agents 120 and/or experts 122. Sensors 128 may include, but are not limited to, network sensors, imaging devices (e.g., cameras, NIR sensors, LiDaR sensors, radar sensors, etc.), and/or audio sensors. Sensors may also be more broadly understood as including any data collecting source from which data can be ingested into platform 104.

Data storage 130 may include any variety of data, for instance, emails, images, videos, sensor data, financial data, healthcare data, inventory data, etc. Data storage 130 may include embedded vector interfaces (e.g., vector databases), proprietary training data for the machine learning models utilized by the ML agents 120 and/or experts 122, custom prompting for the machine learning models, etc. Data storage 130 may also include processed data, such as 3D and 4D image data generated based on image data. The 3D and 4D image data may be annotated and used to train machine learning models (e.g., transformer models) used by the ML agents 120 and/or experts 122 for querying objects and/or other detectable features of the image data.

User interface 118 of AI platform 104 may enable users to interact with and create ML agents 120 and/or experts 122. For example, a user may provide a request/prompt via user interface 118. The request may include, but is not limited to, a natural language prompt and/or other media data (e.g., image, audio, text). The request may be initially received by an ML agent 120 including an LLM trained to receive and process user inputs to determine a context of the input. The context may include a particular domain associated with the request and/or a semantic description of the request. The ML agent may then transmit the request and context to at least one of the orchestrator 124, another ML agent 120, or an expert 122. For instance, in some examples where orchestrator 124 is not utilized, the initial ML agent 120 may broadcast the request and context to all other ML agents connected to the AI platform 104. The request may be received by one or more of the other ML agents 120. The other ML agents 120 may condition or clean up the request (e.g., remove irrelevant words, etc.), then check the request and context against the published context (e.g., DSL capability, such as an ability to communicate with a particular database or API) of the respective ML agent 120. Requests that do not comply with the respective ML agent's context are ignored, ensuring each ML agent 120 only processes relevant commands.

In some examples, when the orchestrator 124 is used, the ML agent that initially processes the request may transmit the request and context to orchestrator 124. Orchestrator 124 may determine the ML agents 120 and/or experts 122 best suited for processing the request based on the request and its context. For instance, if the request is associated with a particular domain (e.g., a CRM system) the orchestrator may select an ML agent 120 and/or expert 122 best suited for communicating with (e.g., executing API calls and/or database queries to that system). The orchestrator 124 may further schedule the ML agents 120 and/or experts 122 for processing the request and may determine control whether the ML agents 120 and/or experts 122 utilize processing power at an edge device (e.g., device 102) or on the cloud (e.g., at a server 106). Once a request is received at an ML agent 120 and/or expert 122, it may be processed to generate an output according to the methods described herein, for instance, by generating DSL scripts and communicating with enterprise systems (via API calls and/or database queries) based on the DSL scripts.

The orchestrator 124 may also determine which ML agents 120 and/or experts 122 are best used based on the overall system utilization. For instance, if the orchestrator 124 detects that utilization of the hardware of system 100 (e.g., servers 106 and/or devices 102) is low, it may start ML agents 120 or ML experts 122 which are highly accurate. In other examples, if orchestrator 124 determines high system load in one or more hardware components such as servers 106 or user devices 102, it may substitute ML agents 120 or ML experts 122 which require less computation resources or which can run on free resources based on the overall requirements for accuracy and speed. In one embodiment the orchestrator 124 may run all user requests using a local server 106 and when that server 106 becomes busy substitute ML agents 120 or ML experts 124 that run on the individual user devices 102 offloading the servers 106 at the cost of some acceptable degradation in accuracy in exchange for fast response time. The orchestrator 124 may also determine that a given hardware in system 100 is unavailable due to a hardware or software problem and reroute and reconfigure the ML agents 120 or experts 122 to run on alternative hardware servers 106 without the need for user intervention.

Users of AI platform 102 may construct ML agents 120 via the user interface 118. To create an ML agent, a user may select a base machine learning model (e.g., an LLM) via user interface 118. The base machine learning model may be any open-source or closed source LLM. AI platform 102 may provide users with access to hundreds of thousands, or even millions of differently specialized LLMs. The LLMs available of each platform may respectively be trained for specialized tasks. For instance, an LLM may be trained and finetuned for querying a particular database, type of database, and/or particular type of data within a database among any number of other specialized tasks. A user may define context for the ML agent 120 via user interface 118. The context may include semantic descriptions of functionality (e.g., a domain for which the ML agent is configured). Users may also add code to the ML agent via user interface 118 for executing certain tasks, for instance, ML agents may include DSL interpreters for executing API calls and/or database queries. The code may be run through a code optimizer when a user deploys the ML agent 120 to a library of ML agents included in AI platform 104 to optimize the code.

A user may also construct an expert 122 (also known as an agent workflow and/or agentic workflow) via user interface 118. To create an expert 122, a user may select one or more ML agents 120, one or more machine learning models, and/or one or more experts 122. Thus, experts 122 can include one or more nested experts 122. The user may further define data sources to be available to the expert. The user may select one or more data sources for each ML agent 120, machine learning model, and/or expert 122 included in the expert 122. The user may further define an output location, e.g., a memory location, at which an output of the expert is to be stored via user interface 188. Additionally, users can define a sequence in which an expert 122 may process data using one or more ML agents 120 and/or machine learning models by arranging aspects of an expert in a dynamic user interface environment.

FIG. 1B illustrates a more detailed depiction of a plurality of interconnected ML agents 120 that may form an expert 122 of FIG. 1A. One or more of the ML agents 120 may be connected to one another and to the orchestrator 124. One or more of the ML agents 120 may also be connected to user interface 118. Each of the ML agents may include a specialized machine learning model such as LLM 120c. In some examples, one or more of the ML agents 120 may include a respective LLM 120e that is trained to generate scripts for particular domains in domain specific languages (DSLs). One or more of the ML agents 120 may also include a DSL interpreter 120f configured to retrieve information and/or execute various actions with respect to resource(s) 150 (e.g., reconfiguring a graphical user interface) using API calls and/or database queries based on the generated DSL scripts. In some examples, one or more ML agents 120 are connected to a particular resource 150 distinct from one or more other ML agents via a respective DSL interpreter 120f based on the respective capabilities of that respective ML agent 120 (e.g., dependent on the domain for which the LLM 120e of the agent 120 is configured to generate DSL scripts for). Additionally, the LLM 120e of one or more of ML agents 120 may be connected to various resources 140 and 142 such that the LLM can access data sources directly without using the DSL interpreter 120f. In some examples, resource 140 includes an embedded vector database. In some examples, resource 142 includes proprietary training data and custom prompting. Resources 140 and/or 142 may additionally or alternatively include any of the data described above with reference to data storage 130.

Each of the ML agents 120 may be configured to execute a plurality of additional or alternative functions, including input conditioning 120a, context checking 120c, input processing using an LLM 120e, DSL interpretation 120f, truth checking 120d, and/or output conditioning. Each ML agent 120 may include software or be connected to software for executing any one or more of the aforementioned functions. Input conditioning 120a may include removing extraneous text (e.g., words) from an input. Context checking may include comparing a context (e.g., a particular domain and/or semantic description of an input request to a context (e.g., a capability, such as an ability to generate scripts for the particular domain) of the ML agent. In some examples, truth checking 120d includes evaluating embedding vector distances to determine a consistency and an accuracy of an output generated by the ML agent 120 with respect to a given input, to data obtained from any of resources 140, 142, and/or 150, or otherwise to ground-truth data. If connected to more LLMs with truth checkers, they can work together as a jury providing an additional layer of hallucination protection. For instance, truth checking 120d may involve a collaborative consensus protocol in which one or more ML agents 120 collaborate to determine a consistency and accuracy of an output generated by one of the ML agents 120. Output conditioning 120b may include a final check that the output from a respective ML agent 120 is consistent with the agent's respective DSL standard.

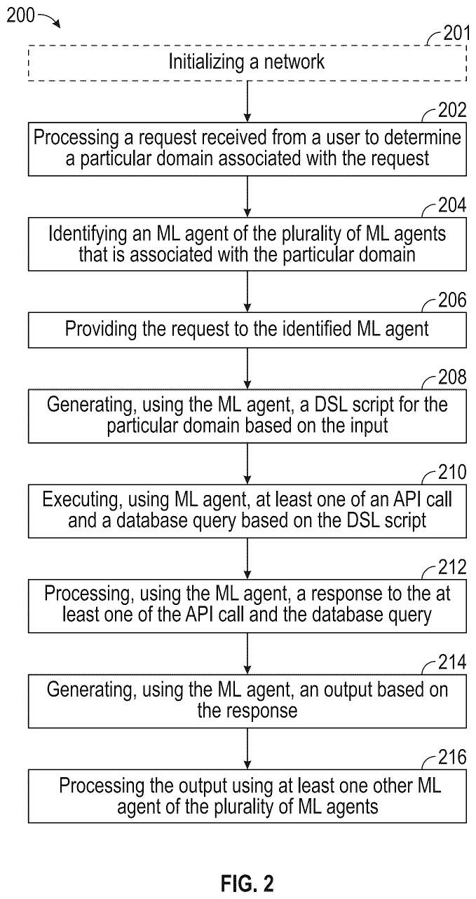

FIG. 2 illustrates an exemplary method 200 for directing a domain-specific request, using an orchestrator, to an ML agent of a plurality of ML agents configured to generate domain specific language (DSL) scripts. One or more steps of the method 200 may be carried out by a computing system such as system 100 described with reference to FIG. 1A. Method 200 is performed, for example, using one or more electronic devices implementing a software platform. In some examples, method 200 is performed using a client-server system, and the blocks of method 200 are divided up in any manner between the server and one or more client devices. Thus, method 200 is not limited to any particular devices. In method 200, some blocks are, optionally, combined, the order of some blocks is, optionally, changed, and some blocks are, optionally, omitted. In some examples, additional steps may be performed in combination with the method 200. Accordingly, the operations as illustrated (and described in greater detail below) are exemplary by nature and, as such, should not be viewed as limiting.

Throughout the exemplary description of the method 200 below, and throughout this disclosure generally, terms such as providing, receiving, sending, transmitting, etc. may be used in various instances to refer to sharing of data between two software modules of the system. It should be understood that, in the context of data sharing between a software module (e.g., an ML agent) running locally on a client device and another software module (e.g., another ML agent or the orchestrator) running remotely on a server or on a different client device, terms such as providing, receiving, transmitting, etc. may involve the transmission of data between two devices. In the context of data sharing between two software module wherein both software module are running locally at the same client device, or wherein both software module are running remotely at a server, terms such as providing, receiving, sending, transmitting, etc. may refer to sharing of data between two software modules.

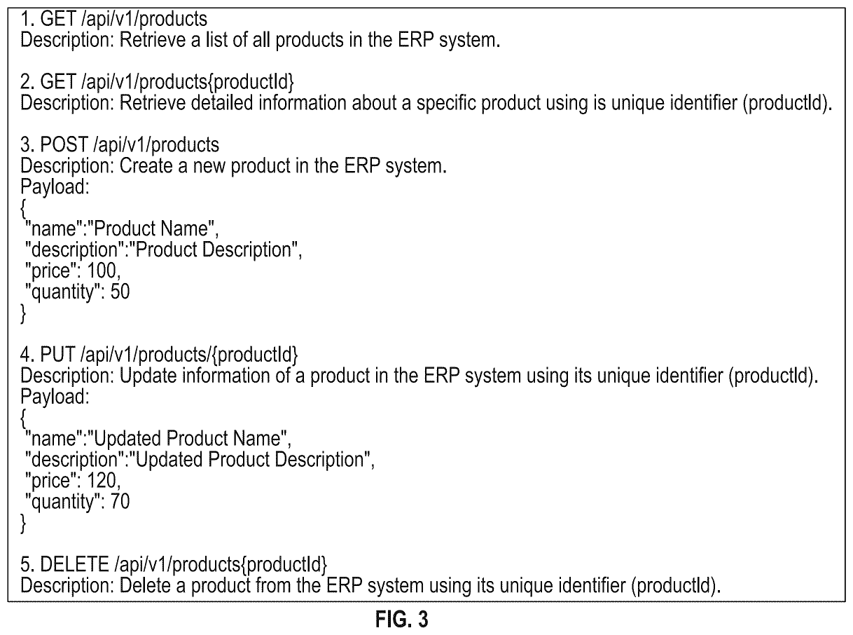

At block 201, the method 200 optionally includes initializing a network. Network initialization may include publishing, by a plurality of ML agents to the network (e.g., the other ML agents and/or the orchestrator), a respective language definition (e.g., their respective DSL definition), along with their context, which may define the scenarios or situations within which the agent should operate (e.g., the domain with which they are configured to interact). In some examples, the context includes a semantic description of a particular domain for which the ML agent is configured. This context enables the ML agent and/or an orchestrator to identify whether a particular request should be processed by that ML agent. All agents in the network may thus be aware of the context of all other agents in the network. An exemplary DSL definition is shown in FIG. 3.

At block 202, the method 200 processing a request received from a user to determine a particular domain associated with the request. In some examples, the request may be processed by an ML agent to determine the particular domain associated with the request before providing the request to the orchestrator. For instance, a user may access a user interface (e.g., interface 102 of system 100). The user interface may enable a user to communicate with one or more ML agents. In some examples, a chatbot ML agent may be trained to receive and generate responses to user requests/prompts, which may include text data (e.g., natural language prompts), image data, audio data, and any other structured or unstructured data. The chatbot LLM may be trained to recognize a domain associated with a user request, for instance, based on a semantic context of the request.

For instance, the chatbot ML agent may recognize that a user request for customer sales and/or demographics information is associated with a CRM system domain. The chatbot ML agent may associate that domain with the request and provide the request and associated domain indication to the orchestrator. It should be understood, however, that the request is not limited to a request received via a user interface and provided to the orchestrator by a chatbot ML agent. The request and indication of the associated domain may be received from any ML agent in the system (e.g., system 100) connected to the orchestrator and may be based on a user input and/or input received from another ML agent. Moreover, in some examples, orchestrator may receive a request and determine the particular domain associated with the request.

At block 204, the method 200 may include identifying an ML agent of the plurality of ML agents that is associated with the particular domain. The orchestrator may include software (e.g., of system 100 described above) configured to receive requests and dynamically provide those requests to appropriate ML agents based on particular domains and/or context (e.g., data context, semantic context) associated with the request. The orchestrator may be configured to determine the appropriate ML agent for processing a request by comparing the particular domain associated with the request to the context and/or DSL definition of the ML agent. The context of the ML agent may include an indication of an ability to generate a DSL script for the particular domain associated with the request (e.g., “I am a CRM agent and can provide information about customer sales and demographics”). The context and/or DSL definition of an ML agent may be specified via a manifest file definition of the ML agent. An exemplary DSL definition of a CRM ML agent is depicted in FIG. 3.

At block 206, the method may include providing the request to the identified ML agent (e.g., any of ML agents 104, 106, 110, 114 of system 100) of the plurality of ML agents that is associated with the particular domain. The request may be transmitted according to any wired or wireless communication protocol, for instance, gRPC, REST, HTTP, TCP, etc. As described above the request may be shared between two software components operating on the same device or between two devices. Upon receipt of the request, the ML agent may condition the request (e.g., remove extrancous words) prior to processing the request. The ML agent may check the request against its own published DSL definition. Requests that do not comply with the agent's definition may be ignored, ensuring each ML agent only processes relevant commands/requests. It should be understood that conditioning the request and checking the request against its own published DSL definition are optional steps. For instance, the request may be conditioned by an ML agent that initially processed the request the request to determine the domain associated with the request, and the function of the orchestrator may be to ensure that only relevant requests are sent to a given LLM. However, checking the request at the ML agent for alignment with its own DSL definition may be useful in examples where an orchestrator is not used, as described in further detail below.

At block 208, the method 200 may include generating, using the ML agent, a DSL script for the particular domain based on the input. The ML agent may employ a machine learning model (e.g., a large language model) to process the request and generate a script in a particular domain language. The ML agent may utilize a DSL definition (e.g., the DSL definition depicted in FIG. 3 to generate the script. The DSL scripts can be interpreted and executed to facilitate interaction with various systems (e.g., enterprise applications, databases, etc.), for instance, using API calls and/or database queries.

At block 210, the method 200 may include executing, using the ML agent, at least one of an API call and a database query based on the DSL script. The API call and/or database query may be executed in runtime by a DSL interpreter. A DSL interpreter may be a software component included as part of or otherwise connected to an ML agent. The DSL interpreter may call an API or query a database to obtain data and context associated with the data from the API and/or database based on the request received at the ML agent. For example, a user may request sales data for a particular time period, division of a company, etc., and an ML agent may query a database to retrieve the pertinent data. In some examples, the API call and/or database query may be executed by a legacy API interface that is available from other enterprise systems, it may be a custom code generated by an ML expert 122 or ML agent 120, or database or other system may directly execute the DSL. In some examples, the DSL may be a known description language such as SQL or a standard format such as an XML interface for an Enterprise Databus in which case, the ML Agent may feed this directly to the database or agent being called. In some examples, the API call and/or database query may be executed according to any of the methods described throughout (e.g., with reference to block 414).

At block 212, the method 200 may include processing, using the ML agent, a response to the at least one of the API call and the database query. The response may include data obtained via the API and/or from the database or may include a description of the data and a resource locator to enable the LLM to obtain the data. The response may include media data (e.g., text data, audio data, image data), metadata, a semantic description of the data, a resource locator for retrieving data, or anything else retrievable via an API call, and/or database query.

At block 214, the method 200 may include generating, using the ML agent, an output based on the response. The output may be based on and/or include at least a portion of the data obtained via the API and/or from the database. Exemplary data that may be obtained by the ML agent via an API call and/or database query executed based on the DSL script includes, but is in no way limited to, financial data (e.g., sales prospecting and analysis), logistics information, call center data, inventory and/or infrastructure data including inventory or infrastructure conditions and damage reports (e.g., from image data processed using object recognition algorithms).

At block 216, the method 200 may processing the output using at least one other LLM agent of the plurality of LLM agents. For example, the data obtained via the API call and/or database query may be provided to an ML agent trained to reconfigure a graphical user interface to display the data based on a context of the data. For instance, the ML agent may be trained to automatically recognize that the data includes sales forecasting data and may configure a user interface to display a graphical (e.g., bar chart) representation of a sales forecast based on the data. In some examples, the ML agent may generate a DSL script that is executed (e.g., by a DSL interpreter) to reconfigure the user interface, for instance, by selecting, rearranging, or otherwise configuring widgets on the user interface to display data obtained via the API calls and/or database queries.

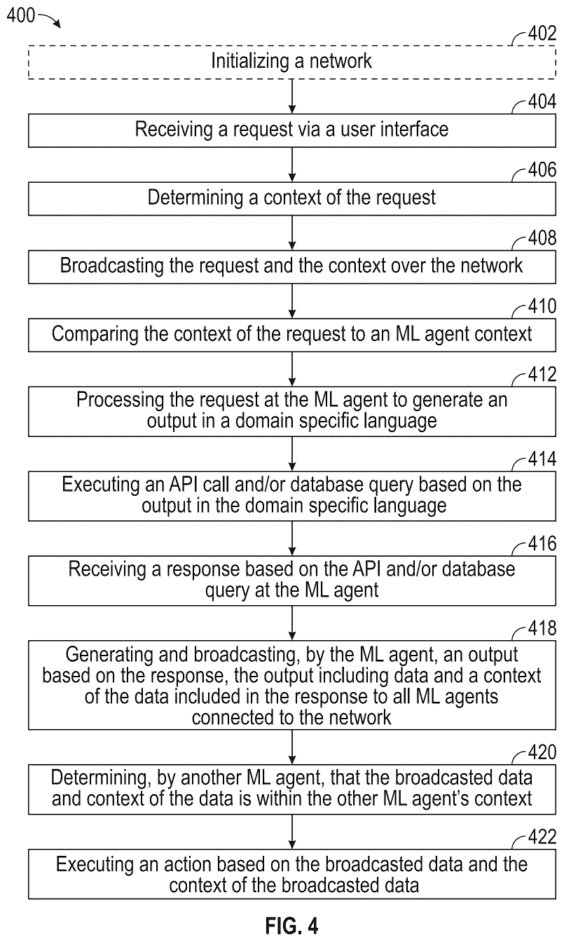

FIG. 4 illustrates an exemplary method 400 for directing a domain-specific requests between large language model (LLM) agents configured to generate domain specific language (DSL) scripts without using an orchestrator. One or more steps of the method 400 may be carried out by a computing system such as system 100 described with reference to FIG. 1A. Method 400 is performed, for example, using one or more electronic devices implementing a software platform. In some examples, method 400 is performed using one or more electronic devices. In some examples, method 400 is performed using a client-server system, and the blocks of method 400 are divided up in any manner between the server and one or more client devices. Thus, while method 400 is not limited to any particular devices. In method 400, some blocks are, optionally, combined, the order of some blocks is, optionally, changed, and some blocks are, optionally, omitted. In some examples, additional steps may be performed in combination with the method 400. Accordingly, the operations as illustrated (and described in greater detail below) are exemplary by nature and, as such, should not be viewed as limiting.

At block 402, the method 400 may include initializing a network. Initializing the network may include all ML agents within the network publishing their DSL definition, along with their context, which defines the scenarios or situations within which the agent should operate. The context may be used in determining which agent should respond to a particular request. The DSL definition and context of each agent may be published to all other ML agents in the network such that all ML agents are aware of the context of all other ML agents in the network. Initialization can be implemented in a variety of ways. For example, a system performing method 400 (e.g., system 100) may initialize itself by starting on a server 106 cluster that itself may be implemented as a Kubernetes server cluster or a single process in a user device 102. The core system may initialize by itself reading a DSL that specifies how the Distributed AI Platform 104 is configured. In some examples, the initial startup may be driven by a Platform DSL that specifies the Terraform specification for how the servers 106 and platform 104 are configured, then a Helm specification for the virtual servers that contain the different components of the distributed AI platform 104. In some examples, the orchestrator 124 may run on a separate hardware infrastructure servers 106 from the other system components such as the hallucination detector 126 for reliability and the data storage 130 or the user interface 118. As the network initializes at block 402, the individual components may, in some examples, utilize specific DSLs to start the individual components. In some examples, the language being used for a platform 104 component may be specified (for instance the use of Python or Typescript), the actual user interface connection may be specific such as a web framework like Flask for the agent connection to end-user inputer, and a DSL would specify how communication between agents facilitated is implemented. In some examples, this DSL may specify by a high performance, open-source universal RPC framework such as gRPC or other methods.

At block 404, the method 400 may include receiving a request via a user interface. The request may include a natural language prompt, other media data (e.g., text data, image data, audio data), and/or any form of structured and/or unstructured data. The request may be received by an ML agent of a plurality of ML agents included in the network. The ML agent that initially receives the user input via the user interface may include an LLM trained to receive and respond to prompts as a chatbot. The ML agent may be configured to condition the input (e.g., by removing extraneous words, etc.) and process the request to determine the context of the request, as described below.

At block 406, the method 400 may include determining a context of the request by the ML agent. The context of the request may include a particular domain associated with the request. For instance, a user may request information regarding damage to infrastructure following a storm or other natural disaster. An ML agent processing this request may determine that it is associated with an infrastructure condition and damage reporting domain that utilizes a particular DSL. The particular domain and/or DSL may be utilized to determine another appropriate ML agent for processing and responding to the request. At block 408, the ML agent that received the request via a user interface may broadcast the request and the context of the request to all ML agents connected to the network.

At block 410, the method 400 may include comparing the context of the request to an ML agent context of one or more ML agents. Each ML agent connected to the network may receive the broadcasted request and context and compare the context associated with the request to its own context. For instance, continuing the example from above, the ML agent that received the request via a user interface may determine that the request is associated with an infrastructure condition and damage reporting domain that utilizes a particular DSL. It may broadcast an indication of that domain (the context) along with the request to all of the other ML agents. Each of the other ML agents may compare the indication of that domain to their own context (e.g., a semantic description of their functionality) and/or to their DSL definition to determine whether they are configured for processing that particular request. If an ML agent determines that it is configured to process a request based on the comparison of the context of the request to its context and/or DSL definition, then it may process the request as described below.

At block 412, the method 400 may include processing the request at the ML agent to generate an output. The ML agent may utilize a machine learning model (e.g., an LLM) to generate the output. The ML agent may also utilize a DSL definition specified in a manifest file of the ML agent to generate the output. The output may include a DSL script that can be used to interact with a resource (e.g., enterprise applications, web applications, databases, etc.)

At block 414, the method 400 may include executing an API call and/or a database query based on the DSL script. The API call and/or database query may be executed in runtime by a DSL interpreter. A DSL interpreter may be a software component included as part of or otherwise connected to an ML agent. The DSL interpreter may call an API or query a database to obtain data and context associated with the data from the API and/or database based on the request received at the ML agent. In some examples, the API call and/or database query may be executed via a small code component (hand written or generated by an ML expert 122) that converts the DSL into the native calls for the API or the database or for an API call in some embodiments, the actually layout of the JSON or other specification for the API call may be simple enough that it can be used directly as the DSL. And in some embodiments the native syntax of the database or enterprise system may be used, so SQL may be the DSL for a database and the XML specification of an enterprise system may be the DSL and be directly generated by the ML agent. In some examples, the API call and/or database query may be executed according to any of the methods described throughout (e.g., with reference to block 210).

At block 416, the method 400 may include receiving, by the ML agent, a response from at least one of the API and the database based on the API call or the database query. The response may include data obtained via the API and/or from the database or may include a description of the data and a resource locator to enable the LLM to obtain the data. The response may include media data (e.g., text data, audio data, image data), metadata, a semantic description of the data, a resource locator for retrieving data, or anything else retrievable via an API call, and/or database query.

At block 418, the method 400 may include generating and broadcasting, by the ML agent, an output based on the response. The ML agent may utilize a machine learning model (e.g., an LLM) to generate the output based on the response form the API and/or database. The output may include data and a context of the data included in the response and may be broadcast to all ML agents connected to the network. The output may be based on and/or include at least a portion of the data obtained via the API and/or from the database.

At block 420, the method 400 may include determining, by another ML agent, that the broadcasted data and context of the data is within the other ML agent's context. The other ML agent may compare the context of the output to its own context (e.g., a semantic description of its functionality/capabilities) and/or its respective DSL definition. If the ML agent determines the context of the output is associated with its own context or DSL definition, it may process the output, for instance to execute an action based on the output as described at block 422.

At block 422, the method 400 may include executing an action by the other ML agent based on the broadcasted data and the context of the broadcasted data. The other ML agent may, for instance, utilize its own DSL definition and machine learning model (e.g., LLM) to generate another DSL script for calling a different API and/or querying a different database. The other ML agent (e.g., a user interface ML agent) may employ its respective LLM to dynamically reconfigure a user interface to display data included in the response from the API and/or database to the user. For example, the output broadcasted at block 420 may have included any of an order status for a sale requested by a customer and obtained via a CRM system API and/or database, healthcare information requested by a doctor (e.g., patient records) and obtained via a hospital API and/or database, inventory information requested by a manager and obtained via an inventory management system API and/or database, etc. It should be understood that the aforementioned examples are in no way meant to be limiting. The other ML agent may include one or more machine learning models (e.g., LLMs) trained to evaluate the context of the data and/or the data itself and dynamically reconfigure a user interface to display the data based on the data context, type of data, volume of data, and/or any other aspect of the data.

The user interface ML agent may also be trained to dynamically reconfigure the user interface based on natural language prompts (e.g., received from a user). For instance, the user interface ML agent may reconfigure a user interface to depict inventory data using a pie chart. A user may request that the data be displayed using a bar chart (e.g., with a natural language prompt). The request may be received directly by the user interface ML agent, or it may be received by another ML agent (e.g., a chatbot ML agent) that routes the request back to the user interface ML agent. The user interface ML agent may reconfigure the user interface to display the inventory data using a bar chart. The user interface ML agent may also learn (e.g., via a continuous and/or periodic machine learning training process) that a type of data should be displayed in a particular manner and/or that a given user prefers data displayed in a particular manner (e.g., that inventory data should be displayed as a bar chart as opposed to a pie chart). As described above, any of the machine learning models included in the ML agents described herein may be continuously and/or periodically retrained for a given task.

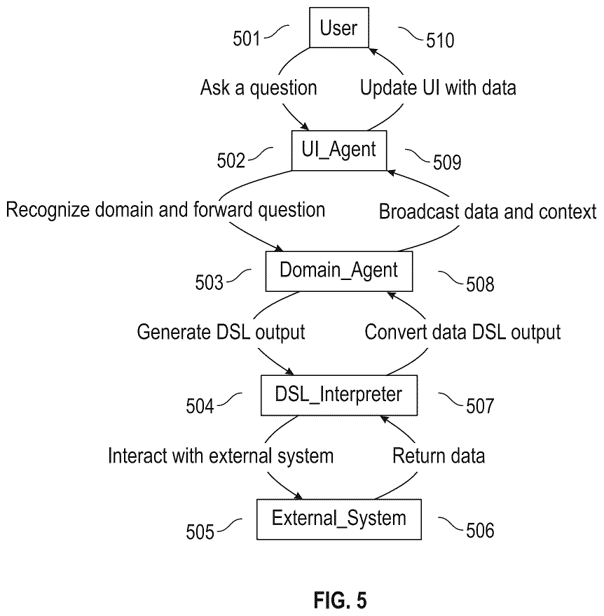

FIG. 5 illustrates a simplistic representation of data flow 500 through a system that either does not utilize an orchestrator and/or in which the orchestrator is bypassed in the illustrated scenario. As depicted, at block 510, a user asks a question (e.g., a natural language prompt through a user interface). At block 502, the question is processed by a user interface ML agent to recognize a particular domain associated with the question and the user interface ML agent routes the question to the appropriate ML agent (e.g., a domain specific ML agent) that is capable of generating DSL scripts for the domain associated with the user's question. At block 503, the domain specific ML agent generates a DSL script using an LLM and provides the DSL script to a DSL interpreter. At block 504, the DSL interpreter obtains data from a resource (e.g., calls an API and/or queries a database, for instance, using SQL) based on the DSL script. At block 506, the resource sends data back to the DSL interpreter. The DSL interpreter then converts the data into a format usable by the domain specific ML agent at block 507, by taking the returned values and in some embodiments labeling the return value in a format that the domain-specific ML agent understands through a mapping table that extracts important values from the DSL from the extraneous syntax that the API call needs. For instance, in some examples, the ML agent may want the “total stock for SKU 1234” and the DSL agent will get a DSL specification in the form or “return in YAML using DSL sku: {{sku_name}}, stock: {{number}}”, the DSL interpreter then knows that the values that need to be extracted and return in a simple format (for example a YAML manifest description.” At block 508, the domain specific ML agent sends the data back to the user interface agent. At block 509, the user interface ML agent uses the data to update the user interface which is displayed to the user at block 510.

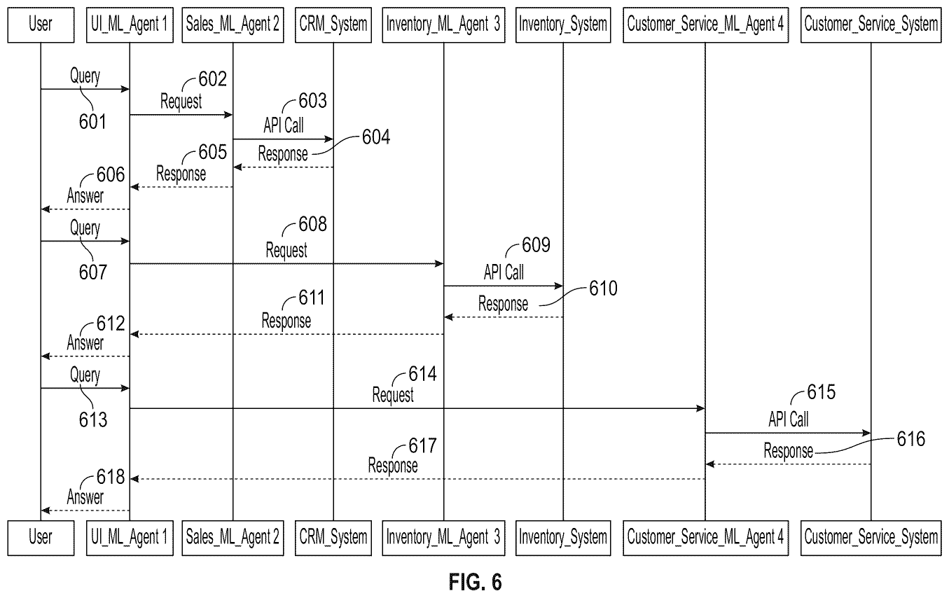

FIG. 6 illustrates an exemplary swim lane diagram of information flowing through a network of ML agents and resources called by the ML agents (e.g., APIs and databases of CRM systems, inventory systems, etc.) in which an orchestrator is not used and/or is bypassed such that ML agents communicate directly with one another. At block 601, a user request is received at ML agent 1 (e.g., via a user interface). In this example, the request may be a request for sales data. ML agent 1 may process the user request, for instance, the remove extraneous words (input conditioning) and to determine a domain associated with the request. ML agent 1 may utilized one or more machine learning models to process the request. The one or more machine learning models of ML agent 1 may be configured, trained, retrained, and/or finetuned for receiving user inputs via a graphical user interface, processing the requests to determine a particular domain associated with the request, transmitting requests to other ML agents along with an indication of the determined domain (e.g., to a particular ML agent including one or more machine learning models trained to generate DSL scripts for that domain, or to all ML agents in the network alongside an indication of the particular domain), and/or generating responses to users (e.g., via natural language outputs and/or dynamic reconfiguration of a user interface).

At block 602, the processed request is received at ML agent 2. ML agent 2 may receive the request based on a particular domain determined to be associated with the request by ML agent 1 and/or ML agent 2. ML agent 2 may include one or more machine learning models configured to generate DSL scripts that can be utilized to call APIs and/or databases associated with a CRM system to obtain the sales data. As described throughout, the DSL scripts generated by the ML agent at block 602 may be processed by a DSL interpreter included in or connected to the ML agent to communicate with a resource such as an API and/or database.

At block 603, a CRM system receives an API call executed based on the DSL script generated by ML agent 2. The API call may include a request for sales information stored in a database or other memory at the CRM system. At block 604, a response to the executed API call may be received by ML agent 2. The response may be routed through the DSL interpreter, and the format of the response may be altered by the DSL interpreter to remove the extraneous parts of the DSL that are not needed by the ML agent prior to receipt by ML agent 2. ML agent 2 may broadcast the data received from the CRM to one or more other ML agents connected to the network. ML agent 2 may also determine a context (e.g., a semantic description) of the data received from the CRM system and send the context to the one or more other ML agents along with the data.

At block 605, the data obtained via the CRM system API along with the context of the data is received by ML agent 1. At block 606, ML agent 1 may process the data and/or data context using one or more machine learning models to configure a user interface for displaying the data. Based on the data and or data context, ML agent 1 may select one or more appropriate widgets for displaying the data. For instance, ML agent 1 may configure one or more bar charts to display sales data plotted over time.

At block 607, a second user request may be received via the user interface at ML agent 1. ML agent 1 may process the request as described at block 601 to determine a particular domain associated with the request. In this example, the second user request may be determined by ML agent 1 to be associated with an inventory system domain. For instance, the user may have requested an update on an amount of one or more types of products currently in inventory.

At block 608, the processed request and indication of the particular domain associated with the request may be received at ML agent 3 (e.g., an inventory management ML agent). ML agent 3 may proceed to generate a DSL script using one or more machine learning models and its respective DSL definition that can be used to retrieve information from a resource (e.g., call an API and/or query a database). At block 609, the DSL script may be executed by a DSL interpreter included in or connected to ML agent 3 to call an API of an inventory system.

At block 610, ML agent 3 may receive a response including data and/or data context from the inventory system. In some examples, ML agent 3 may process the data received from the inventory system to determine a context of the data. The response from the inventory system may again be routed through the DSL interpreter, and the format of the response may be altered by the DSL interpreter to remove the extraneous parts of the DSL that are not needed by the ML agent prior to receipt by ML agent 3. ML agent 3 may broadcast the data received from the inventory system and the data context either received from the inventory system or determined by ML agent 3 to one or more other ML agents connected to the network.

At block 611, the data obtained via the inventory system API along with the context of the data is received by ML agent 1. At block 612, ML agent 1 may process the data and/or data context using one or more machine learning models to configure a user interface for displaying the data. Based on the data and or data context, ML agent 1 may select one or more appropriate widgets for displaying the data. For instance, ML agent 1 may configure the user interface to display a pie chart depicting a number of each product included in inventory. It should be understood that ML agent 1 may determine any other appropriate manner of reconfiguring the user interface to display the data.

At block 613, a third user request may be received via the user interface at ML agent 1. ML agent 1 may process the request as described at block 601 to determine a particular domain associated with the request. In this example, the second user request may be determined by ML agent 1 to be associated with a customer service system (e.g., a call center). For instance, the user may have requested information about previous interactions with a caller to a call center.

At block 614, the processed request and indication of the particular domain associated with the request may be received at ML agent 4 (e.g., an customer service ML agent). ML agent 4 may proceed to generate a DSL script using one or more machine learning models and its respective DSL definition that can be used to retrieve information from a resource (e.g., call an API and/or query a database). At block 615, the DSL script may be executed by a DSL interpreter included in or connected to ML agent 4 to call an API of a customer service system.

At block 616, ML agent 4 may receive a response including data and/or data context from the customer service system. In some examples, ML agent 4 may process the data received from the customer service system to determine a context of the data. The response from the customer service system may again be routed through the DSL interpreter, and the format of the response may be altered by the DSL interpreter to remove the extraneous parts of the DSL that are not needed by the ML agent prior to receipt by ML agent 4. ML agent 4 may broadcast the data received from the customer service system and the data context either received from the customer service system or determined by ML agent 4 to one or more other ML agents connected to the network.

At block 617, the data obtained via the customer service system API along with the context of the data is received by ML agent 1. At block 618, ML agent 1 may process the data and/or data context using one or more machine learning models to configure a user interface for displaying the data. Based on the data and or data context, ML agent 1 may select one or more appropriate widgets for displaying the data. For instance, ML agent 1 may configure the user interface to display a call log, issue log, or other illustration of previous interactions of a given customer with the call center. It should be understood that ML agent I may determine any other appropriate manner of reconfiguring the user interface to display the data.

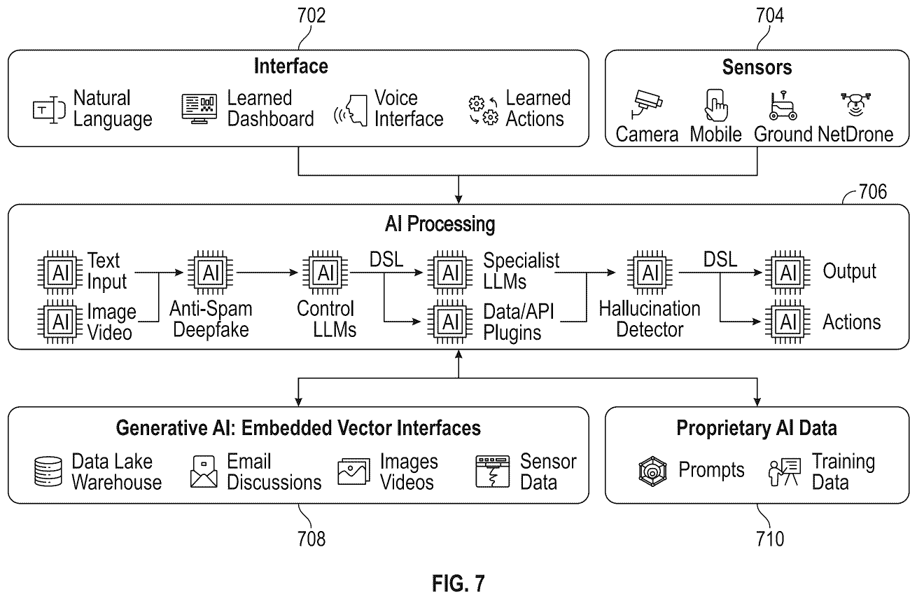

FIG. 7 illustrates an exemplary platform 700 that may include one or more elements of system 100 and/or may be utilized for system 100 and may be configured to perform any of the methods described herein. Platform 700 may include an interface 702 that enables users to interact with a processing pipeline 706 that includes a plurality of ML agents and/or experts. In some examples, one or more of the “LLMs” depicted in FIG. 7 is a collection of ML agents that may use DSLs and/or communicate with each other to carry out specific functions, such as hallucination detection, user interface configuration, data retrieval, etc. Pipeline 706 may include thousands, hundreds of thousands, and/or millions of specialized machine learning models (e.g., included in ML agents). The processing pipeline may be connected to sensors 704, embedded vector data interfaces 708, and proprietary data storage 710, each of which may be sources of data for the ML agents. One or more of the ML agents and/or experts included in pipeline 706 may be continuously and/or periodically retrained, finetuned, or otherwise updated to improve performance/tailor the agent or expert for a specific specialized task. In some examples, each agent may be continuously or periodically updated based on all data or a subset of all of the data stored in a memory of platform 700. In some examples, user queries/requests may be received via interface 702 and dynamically routed to one or more components of processing pipeline 706. The one or more components of processing pipeline 706 may call on data included in the embedded vector databases 708 to process the user request and generate an output and/or execute an action.

The ML agents and/or experts included in pipeline 706 may thus be configured to receive inputs and generate outputs that can be used render dynamic displays on interface 702. Pipeline 706 may include a plurality of specialized ML agents, each including one or more machine learning models trained, retrained, and/or finetuned for a respective task. For instance, as shown, the pipeline 706 may include an anti-spam deepfake detection ML agent configured to detect spam and/or deepfake (e.g., images, text, video) inputs to the system. Pipeline 706 may include a control ML agent. The control ML agent and/or expert may include a relatively larger LLM configured to, for instance, teach the smaller LLMs (e.g., via teacher-student machine learning model training), perform prompt refinement, monitor for drift among smaller specialized models, and in accordance with detecting specialized model drift, can handle processing while the drift in the specialized models is corrected. Pipeline 706 may also include a hallucination detector ML agent and/or expert which may be configured to review outputs of various ML agents and/or experts for accuracy and consistency as described throughout.

The pipeline 706 is responsible for the scheduling, management and control of the overall system (e.g., system 100). Pipeline 706 may store the constraints and operational status of AI platform 104, servers 106 and/or user devices 102 in the overall hardware of system 100. The Pipeline 706 may have a dynamic scheduler (e.g., such as the orchestrator 124 described throughout) which converts all the ML agents running and their runtime performance, hardware requirements and real-time performance requirements. The dynamic scheduler may create a schedule of ML agents to be run across the system and work to maximize hardware utilization by taking all ML agents that are ready to run and comparing them with available hardware. The dynamic scheduler may then dispatch in the execution of the ML agents so that as many downstream agents in an expert 122 (e.g., agent workflow or agentic workflow) can be run. The dynamic scheduler may also examine response requirements and may dispatch agents that have real-time requirements while stalling those agents that do not to provide maximum response time. The pipeline 706 look across all the agents in the system to determine which agents may real-time requirements and those that do not provide maximum response time and the pipeline 706, in some examples, may be distributed across multiple servers 106 and/user devices 102. In some examples, the pipeline 706 may be completely run in one or more user devices 102 for maximum scalability. The pipeline 706 in this case would dispatch ML agents (e.g., using the dynamic scheduler/orchestrator) to remote machines and depending on their response time dispatch agents locally on the user device 102 if there is capacity to find alternative servers 106 that have available compute. In some examples, the pipeline 706 may be distributed across user devices 102 and servers 106 so that all locally executable agents are run by the pipeline on 706 and then all components requiring servers are sent to a server 106 based orchestrator. Finally in some examples, the pipeline 706 may be run on a server only in which case user devices 102 send their desired ML agents 102 or experts 122 to a server 106 and it handles dispatch of agents and then results are returned to the user devices 102.

In some examples, interface 702 is connected to one or more machine learning models (e.g., LLMs) trained to receive and respond to user requests via a natural language (e.g., text), image (photograph, video, etc.), and/or audio (e.g., voice) interface. Interface 702 may itself be managed with a DSL so that the one or machine learning models can dynamically change the user interface in the same way that they operate with other parts of the system. In one embodiment, the user interface DSL may specify a series of “components” on a dashboard 702 and when those components need to move or change, instead of using traditional programming languages, a DSL is used (e.g., by an ML agent) that specifies the content of each component and their location and interactivity. One or more of the machine learning models connected to the interface and configured to receive and respond to user requests may be included in the processing pipeline (e.g., as part of respective ML agents). The one or more machine learning models connected to the interface 702 may be continuously trained and retrained based on user interactions received via the interface 702, data received from sensors 704 (e.g., directly or via queries to embedded vector interfaces 708). The one or more machine learning models may thus continuously learn to generate improved user dashboard interfaces based on feedback from a user received directly from the interface, additional training data ingested via sensors 704 and/or training data stored in proprietary data storage 710. In some examples, interface 702 may be configured to enable users to construct experts and/or ML agents, as described above.

FIG. 8 illustrates an exemplary ML agent/model 806 that may be utilized in the systems and methods described herein. ML agent 806 can be constructed by a user via a user interface 804. A user may select a base machine learning model (e.g., LLM), define one or more business rules (e.g., computer executable programming instructions for various actions to be performed by the ML agent). The code may be optimized prior to deploying the ML agent 806 to a network (e.g., Al platform 104). Code may also be optimized during deployment of ML agent 806 to the AI platform 104 so that the system may fine tune itself based on new inputs dynamically where a “teacher” ML expert is running and it generates input and output streams for a code optimizer that is run while the system is in operation. As shown ML agent 806 may be connected to a plurality of input data sources 808. The ML agent may be configured to communicate with input sources 808 via DSL scripts generated by the selected base model and executed by a DSL interpreter (e.g., part of the business rules/code provided by a user) to call APIs and/or query databases. The inputs may include files, RAG, databases, existing code, APIs, multimedia (e.g., 3D and 4D images, etc.). Each ML agent 806 may be configured to communicate with a subset (e.g., one or more) of these data sources using a particular DSL. In some examples the ML agent 806 may be configured to generate outputs 810 (e.g., using the selected base model). Outputs 810 may include, for instance, memos, charts, audits, logs, multimedia, 4D multimedia, robotic actions, etc., dependent on the training/finetuning of the selected base model and/or business rules (e.g., computer executable code) of the respective agent. Users may interact with (e.g., prompt) the ML agent 806 via user interface 802. Using, for instance, the interface illustrated in FIG. 8, new ML agents can be introduced to the network without necessitating modifications to the existing ML agents, a significant improvement over traditional methods that frequently require extensive reconfiguration when incorporating new systems.

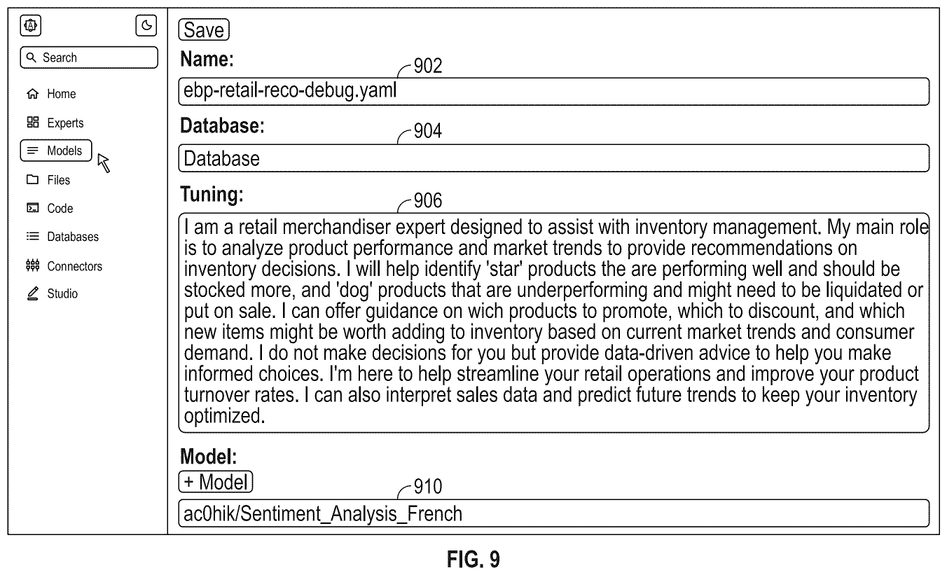

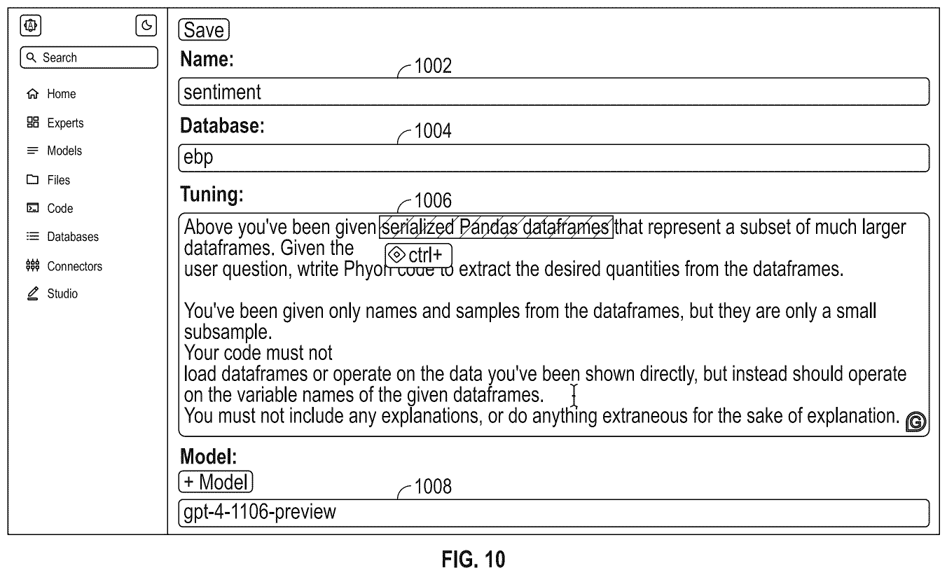

FIG. 9 illustrates an exemplary user interface for constructing an ML agent. The user interface includes a plurality of user affordances for selecting and configuring various attributes of the ML agent. A first affordance 902 may enable a user to define a name for an ML agent. A second affordance 904 may enable a user to define a database to which the ML agent is connected/configured to retrieve data from, for instance, suing DSL scripts generated by an LLM of the ML agent. A third user affordance 906 enables a user to finetune the model using custom tuning (e.g., semantic descriptions that tune a model's performance to respective tasks, as shown). A fourth user affordance 908 enables a user to select a base machine learning model (e.g., LLM) for the ML agent. As shown, the ML agent depicted in FIG. 9 is configured to analyze product performance and provide inventory recommendations. FIG. 10 illustrates another exemplary user interface for constructing an ML agent. The ML agent illustrated in FIG. 10 is configured to perform sentiment analysis. As shown, a user has defined a name (“sentiment”) using affordance 1002, a database using affordance 1004, tuned the model using affordance 1006, and selected a base model using affordance 1008.

FIG. 11 illustrates an exemplary expert 1108 that includes a plurality of ML agents and/or machine learning models (e.g., LLMs) for performing different tasks. Expert 1108 may be connected to a first user interface configured to enable users to find particular experts, request recommended experts for particular tasks, score expert performance, and/or select experts from an expert marketplace. Expert 1108 may be connected to a second user interface 1102 configured to enable users to interact with (e.g., prompt) experts for various tasks. As shown, expert 1108 may include a first plurality of ML agents (agents 1-4), each respectively configured to communicate with a particular input source (e.g., files, databases, code, APIs, multimedia). Each of the first plurality of ML agents may be configured to generate scripts in a particular DSL for communicating with the particular input via API calls or database queries. Expert 1108 may include a second plurality of ML agents (agent 5 and 6) configured to process/analyze the outputs generated by agents 1-4. For instance, ML agent 5 may include an LLM trained to analyze and highlight differences between outputs respectively generated by ML agents 1-4. ML agent 6 may be configured to generate recommendations based on the output of ML agents 1-4 and/or ML agent 5. The expert 1108 may include a third plurality of ML agents (ML agents 7-10) respectively configured (e.g., include an LLM trained for a particular task and/or code that when executed enables the ML agent to perform a particular task) to generate outputs and/or execute actions based on the outputs of any of ML agents 1-6. For instance, ML agent 7 may be configured to generate memos, ML agent 8 may be configured to generate logs, ML agent 9 may be configured to generate multimedia, and ML agent 10 may be configured to generate control instructions for robotics systems.

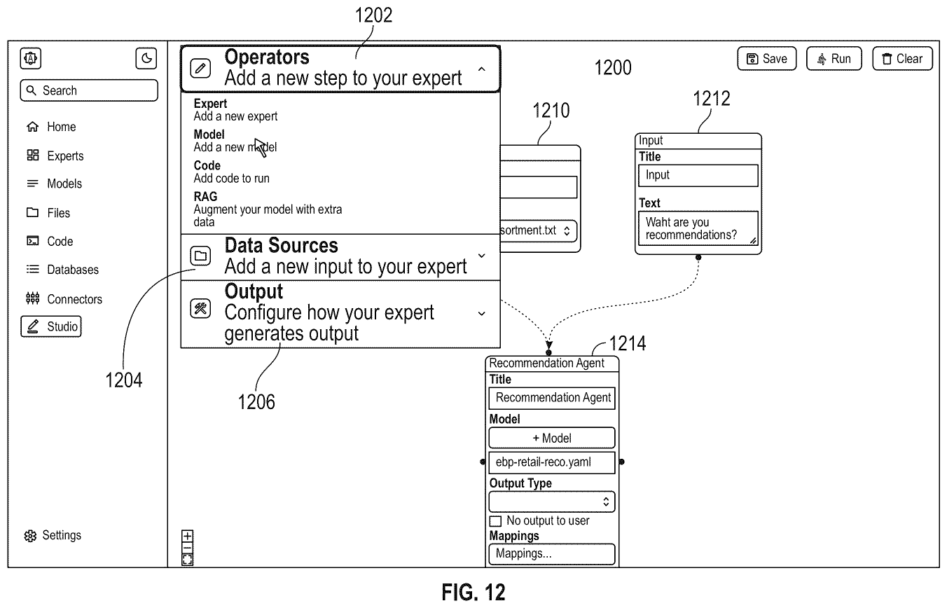

FIG. 12 illustrates an exemplary user interface 1200 for constructing experts such as expert 1108. As shown, FIG. 12 includes a plurality of affordances for selecting different aspects of an expert. A user can include experts (e.g., an expert within an expert), machine learning models, code, RAG (e.g., data), and/or ML agents via affordance 1202. A user can select one or more data sources via affordance 1204, and a user can select a storage location for an output via affordance 1206. As shown, a user has selected a recommendation ML agent 1214, an input 1212 (e.g., prompt), and a data source 1210. The user has arranged the ML agent 1214, input 1212 (e.g., prompt), and data source 1210 on the user interface such that the input 1212 and data source 1210 are connected to the ML agent 1214. The ML agent can receive the input 1212 and data from the data source 1210 to generate an output when a user runs the expert.

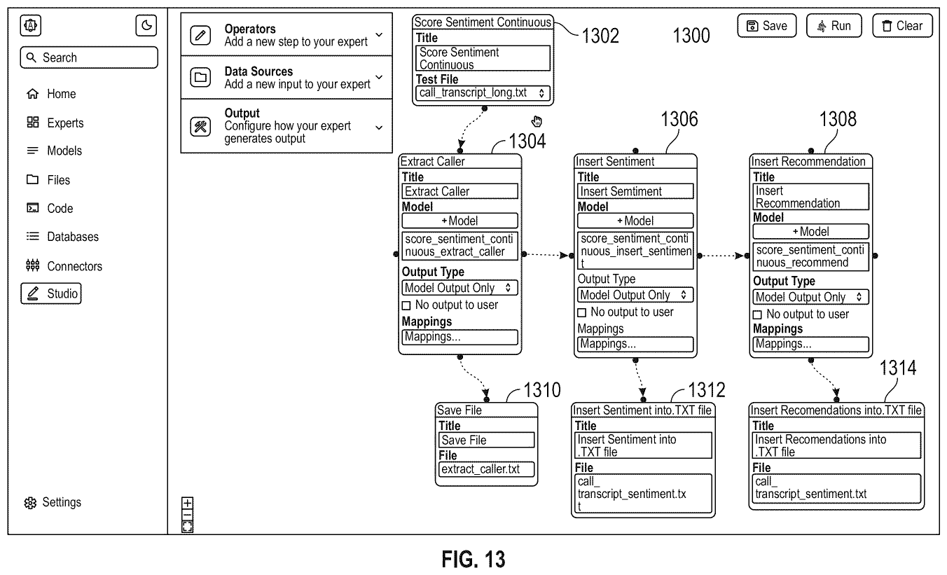

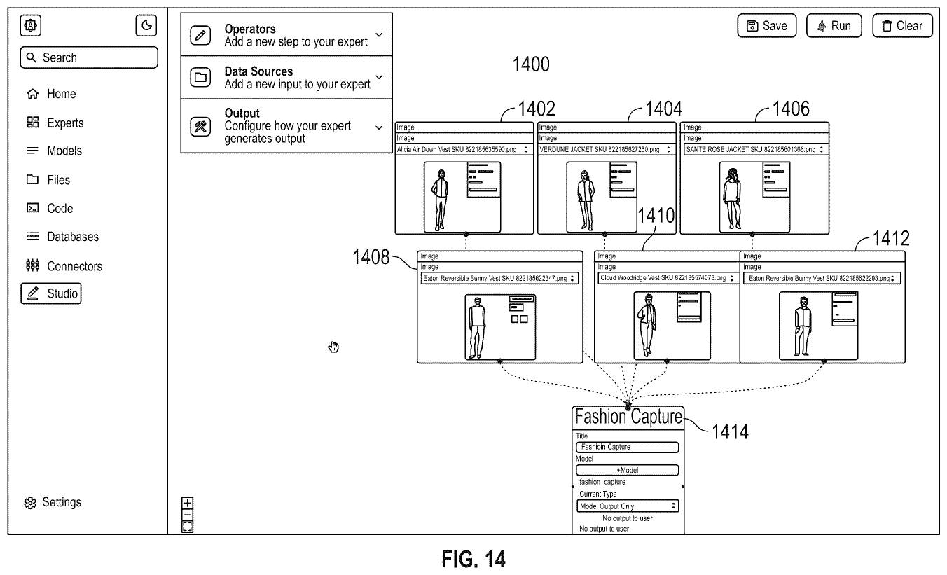

FIG. 13 illustrates another exemplary expert constructed using an exemplary user interface 1300. As shown a user has selected a data source 1302 that is provided to a first ML agent 1304 configured to extract caller data from the input data. The first ML agent 1304 is connected to a second ML agent 1306 configured to score a sentiment based on the input data. The second ML agent 1306 is connected to a third ML agent 1308 configured to generate a recommendation. ML agents 1304, 1306, and 1308 are respectively connected to output locations 1310, 1312, and 1314 in which the ML agents are respectively configured (according to the arrangement on the user interface) to store their respective outputs. FIG. 14 illustrates another exemplary expert constructed using an exemplary user interface 1400. As shown a user has selected a plurality of data sources 1402-1412 that include fashion data, each connected to a single ML agent 1414. The ML agent 1414 is configured to receive data from each of the data sources 1402-1412 and generate an output based on the fashion data (e.g., a description of fashion trends based on products included in a vendor's online catalogue).

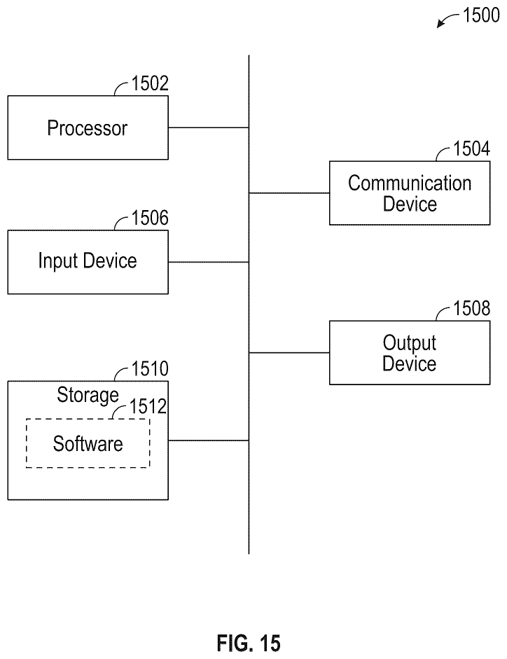

FIG. 15 illustrates an exemplary computing device 1500 that may be used for creating and deploying plugins for use with web-hosted large language model applications, which can be used in accordance with one or more examples of the disclosure. Device 1500 can be a client computer or a server. As shown in FIG. 15, device 1500 can be any suitable type of microprocessor-based device, such as a personal computer, workstation, server, or handheld computing device (portable electronic device) such as a phone or tablet. The device can include, for example, one or more of processors 1502, input device 1506, output device 1508, storage 1510, and communication device 1504. Input device 1506 and output device 1508 can generally correspond to those described above and can either be connectable or integrated with the computer.

Input device 1506 can be any suitable device that provides input, such as a touch screen, keyboard or keypad, mouse, or voice-recognition device. Output device 1508 can be any suitable device that provides output, such as a touch screen, haptics device, or speaker.

Storage 1510 can be any suitable device that provides storage, such as an electrical, magnetic, or optical memory, including a RAM, cache, hard drive, or removable storage disk. Communication device 1504 can include any suitable device capable of transmitting and receiving signals over a network, such as a network interface chip or device. The components of the computer can be connected in any suitable manner, such as via a physical bus or wirelessly.

Software 1512, which can be stored in storage 1510 and executed by processor 1502, can include, for example, the programming that embodies the functionality of the present disclosure (e.g., as embodied in the devices as described above). For example, software 1512 can include software for performing one or more steps of method 200 of FIG. 2.

Software 1512 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1510, that can contain or store programming for use by or in connection with an instruction execution system, apparatus, or device.

Software 1512 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1500 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, TI or T3 lines, cable networks, DSL, or telephone lines.

Device 1500 can implement any operating system suitable for operating on the network. Software 1512 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

### Example Use Cases

### Use Case 1: Sales Inquiry Handling

In a scenario where an online business uses the systems and methods described herein for handling customer queries, the process may work as follows. A customer may interact with a chatbot ML agent asking about a status of their order. The chatbot ML agent, recognizing the sales-related question, may direct the inquiry to a CRM ML agent. The CRM ML agent, upon receiving the user's command and its own DSL definition, may check the CRM system for the order status. Once the information is obtained, it may be broadcasted along with the CRM Agent's context to all other ML agents. A user interface ML agent, recognizing the context, may update the user interface to display the requested order status to the customer.

### Use Case 2: Healthcare Information System

Consider a hospital that employs this invention to manage patient information. A doctor, needing to know a patient's medical history, interacts with the system. A doctor ML agent may recognize the medical context of the inquiry and route it to a patient records ML agent. The patient records ML agent may retrieve the patient's medical history from the hospital's database and broadcast the information along with its context to other ML agents. The user interface ML agent may update the user interface, allowing the doctor to view the patient's medical history.

### Use Case 3: Supply Chain Management

In a supply chain management setting, a manager may want to know the current inventory levels of a specific product. A manager ML agent may recognize the inventory-related question and send it to an inventory ML agent. The inventory ML agent may retrieve the current inventory levels from the inventory management system and broadcast the information along with its context. The user interface ML agent may update the manager's interface to show the current inventory levels.

### Use Case 4: Call Center Operations

In a call center environment, a customer service representative (CSR) may need to quickly access information from various systems to assist a caller. The CSR may interact with the system to retrieve details about the caller's previous interactions. A CSR ML agent, understanding the context of the request, may direct it to a call history ML agent. The call history ML agent may fetch the caller's interaction history from the customer relationship management (CRM) system and broadcast the information with its context. Simultaneously, the CSR might request information from other agents like a billing ML agent or a technical support ML agent depending on the caller's issue. The user interface ML agent may dynamically update the CSR's interface to present all the relevant information in an easy-to-understand format, allowing the CSR to swiftly resolve the caller's issue.

It should be understood that the aforementioned examples are not meant to be limiting. Further, an orchestrator may be used in any of the aforementioned examples to dynamically route requests between different ML agents. Various modifications, alterations and combinations can be made by those skilled in the art without departing from the scope and spirit of the claims.

1. A method for directing a domain-specific request to a machine learning (ML) agent of a plurality of ML agents configured to generate domain specific language (DSL) scripts, the method comprising, at a computing system:
processing a request received from a user to determine a particular domain associated with the request;
identifying an ML agent of the plurality of ML agents that is associated with the particular domain;
generating, using the ML agent, a DSL script for the particular domain based on the request;
executing, using the ML agent, at least one of an API call and a database query based on the DSL script;
processing, using the ML agent, a response to the at least one of the API call and the database query;
generating, using the ML agent, an output based on the response; and
processing the output using at least one other ML agent of the plurality of ML agents.

2. The method of claim 1, wherein the request is processed by another ML agent to determine the particular domain associated with the request before transmitting the request to the orchestrator.

3. The method of claim 1, wherein the request is based on a natural language prompt received via a user interface.

4. The method of claim 1, wherein the request comprises a natural language prompt generated by another ML agent of the plurality of ML agents.

5. The method of claim 1, wherein the request comprises at least one of text data, image data, and audio data.

6. The method of claim 1, wherein the orchestrator is configured to determine the appropriate ML agent by comparing the particular domain associated with the request to a DSL definition of the ML agent.

7. The method of claim 6, wherein the DSL definition of the ML agent comprises an indication of an ability to generate a DSL script for the particular domain associated with the request.

8. The method of claim 6, wherein the DSL definition of the ML agent is specified via a manifest file definition of the ML agent.

9. The method of claim 1, wherein the orchestrator is configured to dynamically utilize server-side computing resources, client-side computing resources, or a combination thereof based on an availability of computing resources.

10. The method of claim 1, wherein any one or more of the plurality of ML agents is configured to dynamically utilize server-side computing resources, client-side computing resources, or a combination thereof based on an availability of computing resources.

11. The method of claim 1, wherein the output is transmitted to a user interface ML agent trained to reconfigure a user interface based on the output.

12. The method of claim 11, further comprising:
receiving, by the user interface ML agent, a user input via the user interface; and
reconfiguring the user interface based on the user input.

13. The method of claim 12, wherein reconfiguring the user interface comprises: selecting one or more widgets based on the user input and data included in the response from at least one of the API and the database.

14. The method of claim 1, wherein a DSL interpreter interprets the DSL script during runtime to execute at least one of an API call and a database query based on the DSL script.

15. The method of claim 14, wherein the DSL interpreter is included in the ML agent.

16. The method of claim 1, wherein the output is transmitted to each of the plurality of ML agents for validating the output.

17. The method of claim 16, wherein validating the output comprises performing a consensus protocol by the plurality of ML agents based on pretrained knowledge of the subset of the plurality of ML agents and external data sources.

18. The method of claim 1, wherein each ML agent of the plurality of ML agents comprises an LLM trained for a different task than an LLM of each of the other ML agents of the plurality of ML agents.

19. A non-transitory computer readable storage medium storing instructions for directing a domain-specific request to a machine learning (ML) agent of a plurality of ML agents configured to generate domain specific language (DSL) scripts, the instructions configured to be executed by one or more processors of a computing system to cause the system to:
process a request received from a user to determine a particular domain associated with the request;
identify an ML agent of the plurality of ML agents that is associated with the particular domain;
generate, using the ML agent, a DSL script for the particular domain based on the request;
execute, using the ML agent, at least one of an API call and a database query based on the DSL script;
process, using the ML agent, a response to the at least one of the API call and the database query;
generate, using the ML agent, an output based on the response; and
process the output using at least one other ML agent of the plurality of ML agents.

20. A system for directing a domain-specific request to a machine learning (ML) agent of a plurality of ML agents configured to generate domain specific language (DSL) scripts, the system comprising one or more processors and memory storing one or more computer programs that include computer instructions, which when executed by the one or more processors, cause the system to:
process a request received from a user to determine a particular domain associated with the request;
identify an ML agent of the plurality of ML agents that is associated with the particular domain;
generate, using the ML agent, a DSL script for the particular domain based on the request;
execute, using the ML agent, at least one of an API call and a database query based on the DSL script;
process, using the ML agent, a response to the at least one of the API call and the database query;
generate, using the ML agent, an output based on the response; and
process the output using at least one other ML agent of the plurality of ML agents.
